(19) United States
(12) Patent Application Publication
(10) Pub. No.: US 2002/0112116 A1
(43) Pub. Date: Aug. 15, 2002

(54) Methods, systems, and computer program products for storing data in collections of tagged data pieces

(76) Inventor: Mark Edward Nelson, Holly Springs, NC (US)

Correspondence Address: MYERS BIGEL SIBLEY & SAJOVEC, PO BOX 37428, RALEIGH, NC, 27627, US

(21) Appl. No.: 10/086,218

(22) Filed: Feb. 26, 2002

Related U.S. Application Data
(63) Continuation-in-part of application No. 09/715,337, filed on Nov. 17, 2000.

(51) Int. Cl. G06F 12/00

(52) U.S. Cl. 711/103; 711/156; 711/170

(57) ABSTRACT

Methods of storing collections of related data in memory can include storing a first collection of related data in a first collection of tagged data pieces and storing a second collection of related data in a second collection of tagged data pieces. Each tagged data piece of the first collection can include a respective header including a first tag identification common to each of the tagged data pieces of the first collection and a fragment identification unique to each of the tagged data pieces of the first collection. Similarly, each tagged data piece of the second collection can include a respective header including a second tag identification common to each of the tagged data pieces of the second collection and a fragment identification unique to each of the tagged data pieces of the second collection wherein the first and second tag identifications are distinct. Related systems and computer program products are also discussed.

### RELATED APPLICATIONS

This application is a continuation-in-part application claiming priority from U.S. Application Serial No. 09/715,337 entitled “METHODS OF STORING TAGGED DATA PIECES AND RELATED SYSTEMS AND COMPUTER PROGRAM PRODUCTS” filed Nov. 17, 2000. The disclosure of U.S. Application Serial No. 09/715,337 is hereby incorporated herein in its entirety by reference.

### BACKGROUND OF THE INVENTION

The present invention relates to the field of memory devices and more particularly to methods, systems, and computer program products supporting storage of data in memory devices.

Modern information processing systems use nonvolatile random access memory devices as mass storage for programs and data. A hard disk is an electromechanical nonvolatile memory device that stores data on magnetic material. More recently, semiconductor nonvolatile memories have been developed. A semiconductor nonvolatile flash memory device, for example, may include a plurality of floating gate metal oxide silicon field effect transistors arranged as memory cells in an array of rows and columns. The floating gate design allows information to be retained after power is removed.

Flash memories have characteristics that may be advantageous for use as mass storage in information processing systems. In particular, a flash memory can be light in weight, can occupy relatively little space, and can consume less power than an electromechanical device such as a hard drive. Further, a flash memory device can be rugged, and may withstand repeated drops that could destroy an electromechanical hard drive. Flash memories have thus been proposed for use in portable electronic devices, such as cellular telephones, where small size, low weight, low power consumption, and mechanical ruggedness are important considerations.

A flash memory may include a plurality of single transistor memory cells that are programmable through hot electron injection and erasable through Fowler-Nordheim tunneling. Programming and erasing of such a memory cell can be performed by passing current through a dielectric surrounding a floating gate electrode. The dielectric, however, may fail after a certain number of programming and erasing operations have been performed so that a flash memory may only be able to provide a finite number of erase-write cycles. Accordingly, manufacturers of flash memory devices typically specify a limit of between 10,000 and 100,000 erase-write cycles for a flash memory cell.

A flash memory cell can be erased by applying a high voltage to the source terminal of the flash memory cell. Because flash memory devices are typically organized into multiple sectors of flash memory cells and because source terminals of memory cells in each sector are connected to one another by metallic busing, an erase operation may erase all flash memory cells in a sector at the same time. Thus, in a sector erase operation, valid data along with invalid data may be erased.

Because of the unique characteristics of flash memory devices, specialized techniques have been developed to manage flash memory storage systems. For example, U.S. Pat. No. 5,956,472 to Ma et al. entitled Method And System For Managing A Flash Memory Mass Storage System discusses methods to provide defect management, wear leveling, and data security to a mass storage system implemented using flash memory. The disclosure of this patent is hereby incorporated herein in its entirety by reference. Notwithstanding the flash memory storage systems discussed above, there continues to exist a need in the art for improved memory storage systems and methods.

### SUMMARY OF THE INVENTION

Methods of storing collections of related data in memory according to embodiments of the present invention can include storing a first collection of related data in a first collection of tagged data pieces and storing a second collection of related data in a second collection of tagged data pieces. Each tagged data piece of the first collection can include a respective header including a first tag identification common to each of the tagged data pieces of the first collection and a fragment identification unique to each of the tagged data pieces of the first collection. Similarly, each tagged data piece of the second collection can include a respective header including a second tag identification common to each of the tagged data pieces of the second collection and a fragment identification unique to each of the tagged data pieces of the second collection wherein the first and second tag identifications are distinct.

### BRIEF DESCRIPTION OF THE DRAWINGS

FIG. 1 is a block diagram illustrating an information processing system according to embodiments of the present invention.

FIG. 2 is a graph illustrating sectors of a memory device having varying sizes according to embodiments of the present invention.

FIGS. 3-4, 6-11, and 14 are flow charts illustrating operations for storing data according to embodiments of the present invention.

FIG. 5 is a diagram illustrating an organization of a tagged data piece according to embodiments of the present invention.

FIGS. 12 and 13 are graphs illustrating scoring of sectors for data placement during sector reclamation according to embodiments of the present invention.

FIG. 15 is a block diagram of a mobile terminal according to embodiments of the present invention.

FIG. 16 is a flow chart illustrating operations for initializing a memory device according to embodiments of the present invention.

FIG. 17 illustrates a sorted list of addresses for tagged data pieces according to embodiments of the present invention.

FIG. 18 illustrates a tagged data piece used to provide collections of tagged data pieces according to embodiments of the present invention.

FIGS. 19A and 19B illustrate fragment lists according to embodiments of the present invention.

FIG. 20 illustrates an all list according to embodiments of the present invention.

FIG. 21 illustrates a directory according to embodiments of the present invention.

FIG. 22 illustrates a data field of an initial tagged data piece of a collection of tagged data pieces according to embodiments of the present invention.

FIG. 23 illustrates a data field of a tagged data piece used to store a database header according to embodiments of the present invention.

FIG. 24 illustrates a data field of an initial tagged data piece of a collection used to store a database table according to embodiments of the present invention.

FIG. 25 illustrates a data field of a non-initial tagged data piece of a collection used to store a record of a database table according to embodiments of the present invention.

FIGS. 26A-C illustrate non-initial tagged data pieces of a collection used to store records of a database table according to embodiments of the present invention.

FIGS. 27A-D illustrate tagged data pieces used to store a record set according to embodiments of the present invention.

FIGS. 28-30 are flow charts illustrating operations for tracking collections of tagged data pieces according to embodiments of the present invention.

FIG. 31 is a flow chart illustrating operations for adding entries to system directory collections according to embodiments of the present invention.

FIG. 32 is a flow chart illustrating operations for removing entries from a system directory collection according to embodiments of the present invention.

FIG. 33 is a flow chart illustrating operations for modifying collections of tagged data pieces according to embodiments of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods or devices. Accordingly, the present invention may take the form of a hardware embodiment, a software embodiment or an embodiment combining software and hardware aspects. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

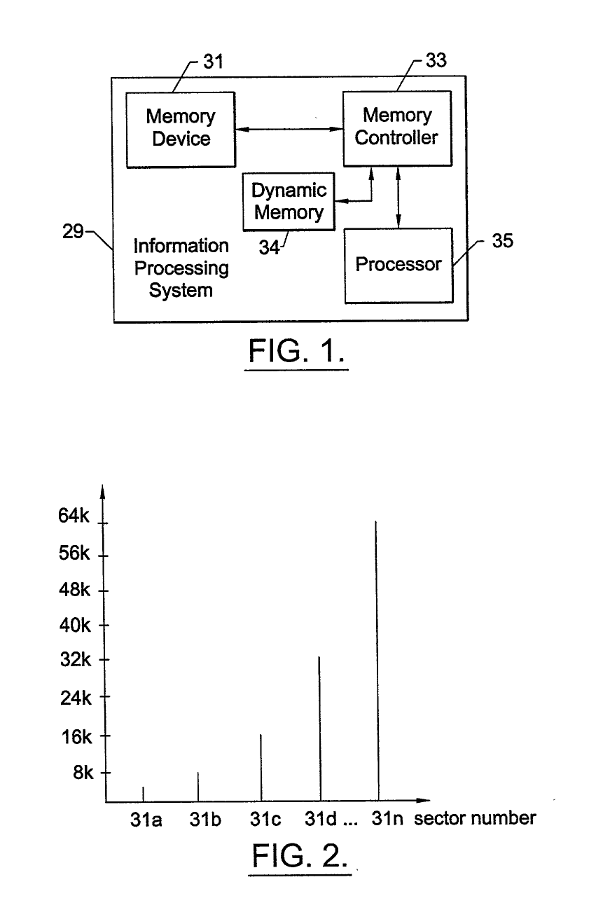

As shown in FIG. 1, an information processing system 29 according to the present invention can include a memory controller 33 used to control a memory device 31, such as a non-volatile integrated circuit flash memory device, to read and write data as needed by processor 35. While shown as separate blocks, the memory controller 33 and/or memory device 31 and/or portions thereof may be considered as being implemented as a part of the processor 35. Alternately or in addition, the memory device 31 may be considered as being implemented as a part of the memory controller 33. In addition, dynamic memory 34 (such as dynamic random access memory) may be provided for use by the memory controller 33. Moreover, the dynamic memory may be considered as separate from the memory controller or as being a part of the memory controller.

As shown in FIG. 2, the memory device 31 can be a non-volatile integrated circuit memory device such as a flash memory device divided into a plurality of sectors 31a-n wherein different sectors can have different sizes. By way of example, sector 31a can have a size of 4k bytes, sector 31b can have a size of 8k bytes, sector 31c can have a size of 16k bytes, sector 31d can have a size of 32k bytes, and sector 31n can have a size of 64k bytes. The memory controller of 33 of the present invention can thus accommodate flash memory devices divided into sectors of different sizes as well as flash memory devices divided into commonly sized sectors. Characteristics of flash memory devices are discussed, for example, in U.S. Pat. No. 5,956,472, the disclosure of which is hereby incorporated herein in its entirety by reference.

Each flash memory device sector 31a-n thus includes a plurality of memory cells wherein each memory cell can store one bit of data, and data stored in the flash memory device can be maintained without power because a flash memory device is nonvolatile. Because the source terminals of memory cells in a sector may be connected by a common bus and each sector may have a separate bus, a sector erase operation can be used to erase all memory cells in a sector without erasing memory cells of other sectors. Moreover, each memory cell in the flash memory device can be addressed by sector and address within the sector. In other words, memory cells within each sector can be identified with consecutive addresses.

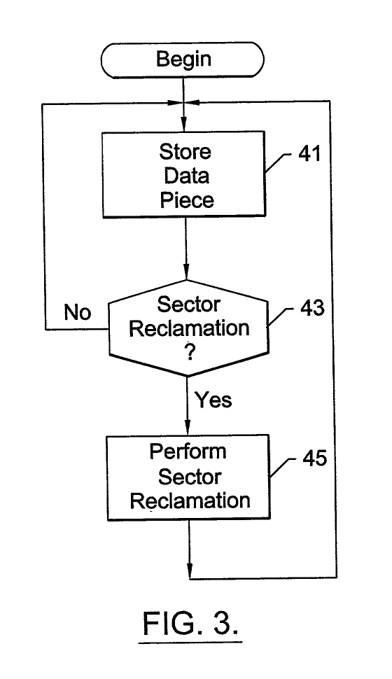

The flow chart of FIG. 3 illustrates operations of the memory controller 33 relating to the storage of data as instructed by the processor 35. For each data storage request generated by the processor 35, the memory controller 33 defines and stores a corresponding data piece at block 41. After storing a data piece at block 41, the memory controller determines at decision block 43 if a sector reclamation operation is desired to provide additional memory space before storing additional data. If sector reclamation is desired at block 43, sector reclamation operations are performed at block 45 before storing additional data pieces at block 41. Otherwise, additional data is stored without performing sector reclamation. Each of the operations illustrated in FIG. 3 will be discussed in greater detail below.

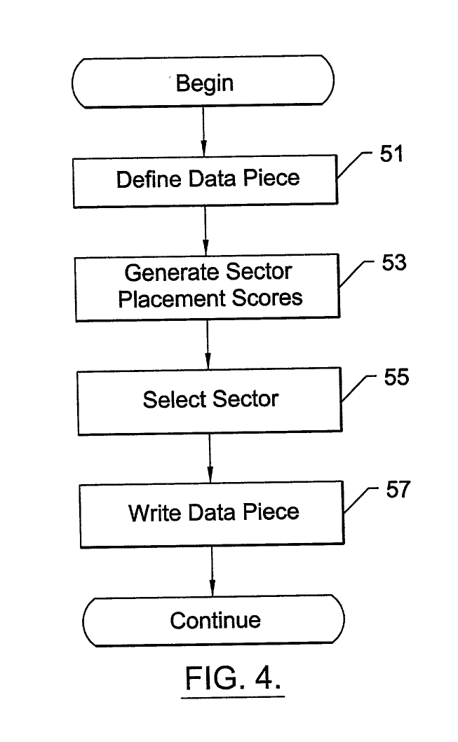

When storing a data piece at block 41 of FIG. 3, the memory controller 33 can define data pieces of varying size based on the data provided by the processor 35 to provide efficient packing of the sectors of the memory device. More particularly, the memory controller 33 can define each data piece as a tagged data piece including a plurality of data bytes provided by the processor 35 and a plurality of header bytes defined by the memory controller 33 at block 51 of FIG. 4.

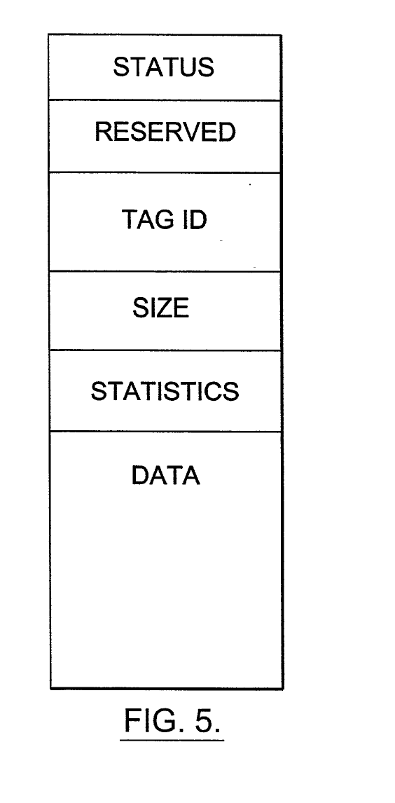

An example of a format for a tagged data piece according to the present invention is illustrated in FIG. 5. As shown, a tagged data piece can be defined to include a data field DATA of a plurality of data bytes provided by the processor 35 and a header defined by the memory controller 33. The data field DATA can vary in size as needed by the processor 35 up to a predetermined maximum data size. The data field, for example, can have a maximum data size of 500 bytes. The header can have a uniform size including a one byte status field STATUS, a one byte reserved field RESERVED, a two byte tag identification field TAG ID, a two byte data size field SIZE, and a four byte statistics field STATISTICS. According to embodiments of the present invention, a size of the data field can vary for each tagged data piece while the header size is constant for each tagged data piece. With a maximum data size of 500 bytes and a header of 10 bytes, for example, a maximum tag size (MaxTagSize) can thus be 510 bytes. One or more of the fields discussed above may be omitted according to alternate embodiments of the present invention. Moreover, fields can be added to the tagged data piece format to support additional functionality. A fragment identification field, for example, can be added to the header to support the storage of data collections in collections of tagged data pieces as discussed in greater detail below with reference to FIGS. 17-20.

According to embodiments of the present invention, a plurality of tagged data pieces can be stored in consecutively addressed memory locations of each of the flash memory sectors 31a-n. Within a sector, a first tagged data piece can be stored in a first group of consecutively addressed memory locations, a second tagged data piece can be stored in a second group of consecutively addressed memory locations, and the first and second consecutively addressed memory locations of the sector can be provided without a gap of memory cells therebetween. In other words, tagged data pieces of different sizes can be written to memory cells of a sector with progressively increasing memory cell addresses so that empty memory cells of the sector are consecutively addressed memory cells at the top (having the highest addresses) of the sector. By storing tagged data pieces of different sizes without empty memory cells therebetween, memory can be efficiently allocated as needed.

The memory controller 33 can then generate a placement score for a data piece for each sector of the memory device 31 at block 53 of FIG. 4, wherein the placement score for a sector defines a degree of suitability of the sector for placement of the data piece therein. For example, a placement score of zero may indicate that the sector is unsuitable for placement of the data piece therein, and placement scores of increasing value can indicate increased suitability of the sector for placement of the data piece therein. A most suitable sector can be selected for placement of the data piece therein, for example, by selecting the sector with the highest placement score.

More particularly, the memory controller 33 can generate the placement scores based on consideration of an amount of empty space available in each sector, an amount of valid data stored in each sector, and a number of erase cycles performed for each sector. In particular, each sector may include a number of bits of valid data stored therein (a sum of bytes of all valid data pieces stored in the sector), a number bytes of invalid data stored therein (a sum of bytes of all invalid data pieces stored in the sector), and a number of bytes of empty space in the sector with neither valid or invalid data. Moreover, the valid data and invalid data stored in a sector can be stored in consecutively addressed memory cells within the sector so that the empty space of the sector is located in consecutively addressed memory cells at the beginning or the end of a sector.

A placement score for a tagged data piece can be determined for each sector, for example, using the following formula:

$$Place Score = 1 \frac{{( ( {2}^{16} - 1 ) - valids {2}^{4 \_ 1} )}^{2}}{\frac{{2}^{16}}{{2}^{1}}} + 4 \frac{( Size - valids - invalds )}{\frac{{2}^{1}}{{2}^{0}}} + \frac{{[ \frac{cycles}{2} - ( {2}^{16} - 1 ) ]}^{2}}{{2}^{16}} . \qquad Equation ( 1 )$$

In this formula, i represents the size of the sector such that i=0 for a 4K sector, i=1 for a 8k sector, i=2 for a 16k sector, i=3 for a 32k sector, and i=4 for a 64k sector; cycles represents the number of erase cycles performed on the sector; size is actual sector size, i.e. 4k, 8k, 16k, 32k, or 64k; valids represents the number of bytes of valid data stored in the sector; and invalids represents the number of invalid bytes stored in the sector. Moreover, a placement score of zero can be assigned to any sector for which the tagged data piece to be stored would not fit in the available empty space.

According to the placement formula of Equation (1), the placement score for a sector increases with greater amounts of empty space available, decreases with greater amounts of valid data stored therein, and decreases with a greater number of previously performed erase cycles. In a memory device with sectors of different sizes, the empty space can be considered as a ratio with respect to sector size so that larger sectors are not necessarily preferred over smaller sectors.

Once placement scores are generated for each of the sectors of the flash memory device 31, the memory controller 33 can select a sector having a suitable placement score at block 55. Using the placement formula discussed above in Equation (1), the sector having the highest placement score may be selected. The tagged data piece can then be written to the selected sector at block 57.

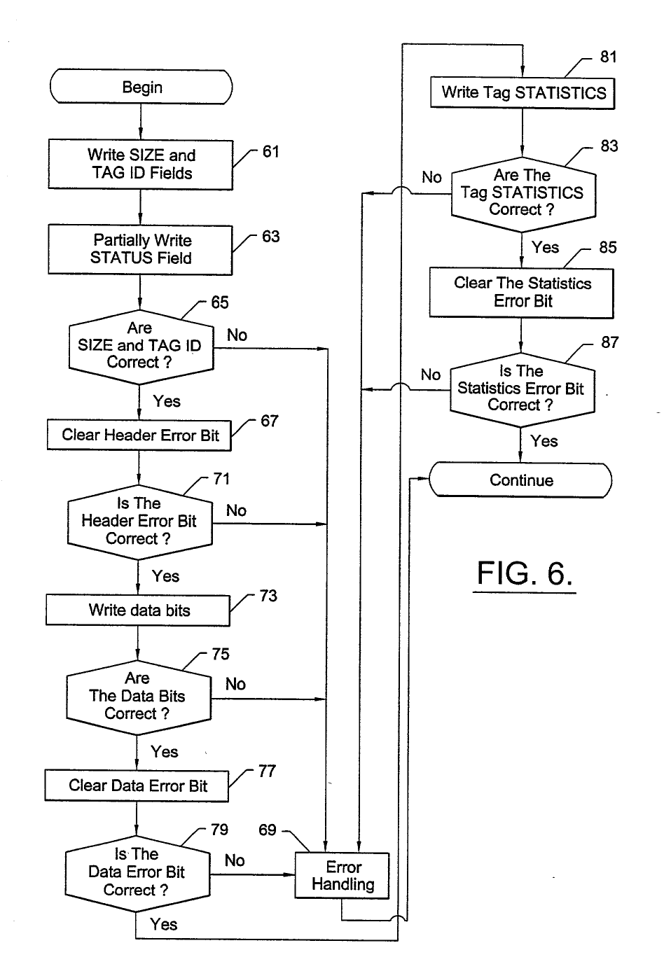

Examples of operations of writing a tagged data piece to a selected sector are illustrated in the flow chart of FIG. 6. As discussed above, the tagged data piece can be written into consecutively addressed empty memory cells of the selected sector in the address order illustrated in FIG. 5. For example, the STATUS field can occupy the lowest addresses of the tagged data piece and the DATA field can occupy the highest addresses of the tagged data piece. Moreover, the consecutively addressed empty memory cells preferably follow the memory cells to which the most recent previous tagged data piece was written in the sector without a gap of memory cells therebetween. While the STATUS, RESERVED, TAG ID, SIZE, STATISTICS, and DATA fields are illustrated as occupying consecutively addressed memory cells in the order shown in FIG. 5, bits of consecutively addressed memory cells are not necessarily written in consecutive time order. For example, a data error bit in the STATUS field may be written after completing writing the DATA field. In a flash memory device, the empty memory cells will initially be at a logic 1 level as a result of the last erase cycle performed on the sector, and each memory cell can be either cleared to a logic zero or maintained as a logic one during a write operation.

As shown in FIG. 6, the memory controller 33 can write a data size in the SIZE field and a unique tag identification in the TAG ID field based on the DATA provided by the processor 35 at block 61. More particularly, the data size can be a number of data bytes provided by the processor for the DATA field, and the tag identification can be a unique identifier for the tagged data piece. The memory controller 33 can also write (clear) some of the bits of the STATUS field to zero while maintaining a data error bit, a header error bit, a status error bit, and a valid bit at a logic one at block 63. The memory controller 33 can then verify that the data size and the tag identification were properly stored in the SIZE and TAG ID fields at decision block 65.

If the data size and tag identification are properly stored, the memory controller can write (clear) a header error bit of the STATUS field to zero at block 67. Otherwise, the memory controller can proceed with error handling procedures at block 69. At decision block 71, the memory controller can verify that the header error bit was properly written, and if not, proceed with error handling procedures. If the header error bit is properly written, the data bytes provided by the processor can be written into the DATA field at block 73. At decision block 75, the stored data bytes can be verified as correct. Error handling procedures can be performed at block 69 in the event that the data bytes do not verify as having been stored correctly. If the data bytes were correctly stored in the DATA field, the data error bit of the STATUS field can be written (cleared) to zero at block 77.

At decision block 79, proper clearing of the data error bit can be verified. If not, the error handling procedures can be executed at block 69. If the data error bit is verified as having been properly cleared, the tag statistics can be written into the STATISTICS field at block 81. The tag statistics, for example, may include information indicating a number of times the data of the tagged data piece has been rewritten, such as a counter that is incremented each time the data is invalidated in one tagged data piece and rewritten as a new tagged data piece. At decision block 83, the memory controller can verify that the tag statistics have been correctly written to the STATISTICS field. If not, error handling procedures can be executed at block 69.

If the tag statistics have been properly written, the statistics error bit of the STATUS field can be cleared at block 85 and verified at decision block 87. If the statistics error bit is properly written, the memory controller can proceed, for example, to determine if sector reclamation is needed as shown at decision block 43 of FIG. 3. After successfully writing a tagged data piece, the valid bit of the STATUS field is maintained at a logic one. The valid bit for a tagged data piece is maintained at a logic one until the data stored in the tagged data piece is no longer valid. Once a determination is made that the tagged data piece is no longer valid, the valid bit can be cleared to zero to indicate that the tagged data piece is no longer valid. A tagged data piece may be invalidated, for example, when the data stored therein has been revised and a new tagged data piece is written with the revised data.

If the memory controller determines that an improper write operation has occurred at any of decision blocks 65, 71, 75, 79, 83, or 87, error handling procedures can be performed at block 69. For example, if the tag size or tag identification do not verify as having been properly written at block 65, the operation of writing the data operation can be terminated with the header error bit remaining a logic one. On subsequent scans of the sector, the memory controller can determine that a header error occurred when writing the data piece, and that no data bits were written so that there is no data field DATA. In other words, the memory controller can determine from the header error that no data was written for the tagged data piece and that the next tagged data piece for the sector will be located following the header (STATUS, RESERVED, TAG ID, SIZE, and STATISTICS fields) of the tagged data piece. Moreover, the memory controller can repeat operations of FIGS. 4 and 6 to attempt to store the data from the processor that was previously stored in error.

Once the tagged data has been written, the size of the tagged data piece can be determined with reference to the tag size provided in the SIZE field. Accordingly, if an error is determined at any of blocks 71, 75, 79, 83, or 87 (errors occurring subsequent to the writing of the data size and the tag identification), the data write can be terminated with the respective error bit(s) remaining at a logic one. On subsequent scans of the sector, the memory controller can determine that an error occurred when writing either the tag data, the tag statistics, and/or the respective data error or statistics error bits. With the header error bit at zero and either the data error or statistics error bits at one, the memory controller can determine that the next tagged data piece for the sector will be located following the DATA field as determined using the tag size stored in the SIZE field. As before, the memory controller can proceed with additional operations of FIGS. 4 and 6 to store the same data from the processor.

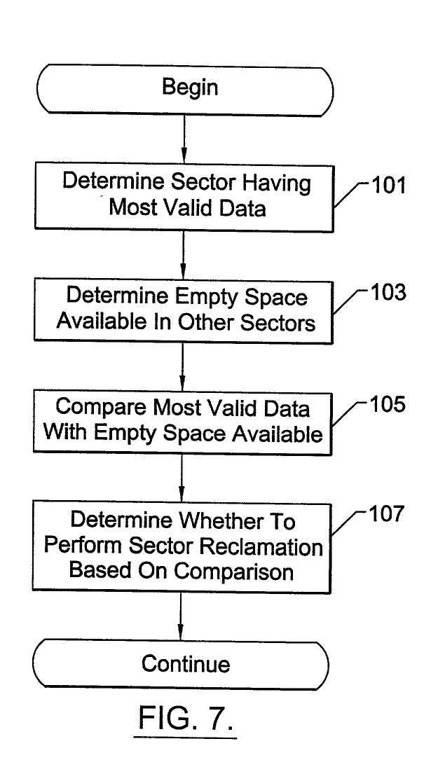

As discussed above with regard to FIG. 3, a data piece having the structure illustrated in FIG. 5 can be stored at block 41 according to additional operations illustrated in FIGS. 4 and 6. After storing each tagged data piece, the memory controller may make a determination at block 43 if sector reclamation operations are needed before performing additional storage operations. Examples of operations that can be used to determine if a sector reclamation operation should be performed are illustrated in FIG. 7.

As shown in FIG. 7, a sector having the most valid data stored therein is selected at block 101. For example, the memory controller can scan each of the sectors of the memory device 31a-n of the memory device 31 and count each of the header and data bytes included in valid tagged data pieces in each sector. As discussed above, valid tagged data pieces will have data, header, and statistics error bits cleared to zero and a valid bit at a logic one level. A count of bytes of invalid data pieces (with a data, header, or statistics bit at logic one or with a valid bit cleared to zero) is not necessary. The largest number of valid bytes stored in a single sector represents the maximum number of bytes of data that may need to be moved in the event of a sector reclamation.

As discussed above, a maximum tag size (MaxTagSize) may be defined by the memory controller such that no tagged data piece can include more bytes (header and data bytes) than the maximum tag size. MaxTagSize, for example, could be defined as 510 bytes. The largest number of valid bytes stored in a single sector can then be divided by MaxTagSize and the remainder removed to provide a highest number of multiples of tagged data pieces (MTv) of the maximum tag size that may need to be stored during a sector reclamation. The number of multiples of tagged data pieces of the maximum tag size indicates whether sufficient empty space is available in the sectors (other than the sector having the most valid data) to store complete tagged data pieces of the maximum size in single sectors.

At block 103, the memory controller can count empty bytes (not included in either valid or invalid data pieces) available for storage in each of the sectors other than the sector including the most valid data. More particularly, for each sector (other than the sector with the most valid data) the memory controller can count the empty bytes, divide the result by MaxTagSize, and remove any remainder to provide a number of multiples of tagged data pieces (MTeⱼ) of the maximum tag size that can be stored in each sector. Each number of multiples of tagged data pieces of the maximum tag size MTeⱼ for each sector (other than the sector including the largest number of valid bytes) can then be summed to provide a maximum number tagged data pieces MTe of the maximum tag size (MaxTagSize) which could be stored during a reclamation procedure. In other words, MTe represents a maximum number of tagged data pieces of the maximum data size (MaxTagSize) that could be stored if the sector having the largest amount of valid data stored therein were reclaimed. Because remaining empty space from a plurality of sectors can be summed to provide for movement of data from a sector being reclaimed, memory controllers according to the present invention do not require maintenance of an empty sector to accommodate sector reclamation.

The memory controller can then compare MTv and MTe at block 105 to determine if a sector reclamation should be performed at block 107. As discussed above, MTv represents a worst case number of valid tagged data pieces of the maximum data size that may need to be stored during a reclamation of the sector including the most valid data, and MTe represents a number of valid tagged data pieces of the maximum data size that could be stored in the other sectors during a reclamation. A sector reclamation may thus be needed if there will not be enough empty space available to accommodate the next data storage operation.

The comparison of MTv and MTe may also accommodate any remainder removed during the calculation of MTv and a subsequent storage of a tagged data piece of the maximum tag size (MaxTagSize), as well as the possibility of a power failure during a subsequent write operation or reclamation. The following comparison can, thus, be used to determine when to perform a sector reclamation:

MTv+4>=MTe. Equation (2)

According to equation (2), a reclamation may be performed if MTv plus four is greater than or equal to MTe. In this situation, the amount of data that may need to be moved to other sectors during a sector reclamation may be approaching an amount of empty space available for storage. The integer 4 can compensate, for example, for any remainder when calculating MTv, the subsequent storage of a tagged data piece of the maximum data size, the possibility of power failure during a subsequent storage, and the possibility of a power failure during sector reclamation. A greater number could be added to accommodate a greater number of contingencies so that sector reclamation is performed more frequently. Alternately, a lesser number could be added to reduce a frequency of reclamation while providing reduced resilience in the event of power failure or other unanticipated events.

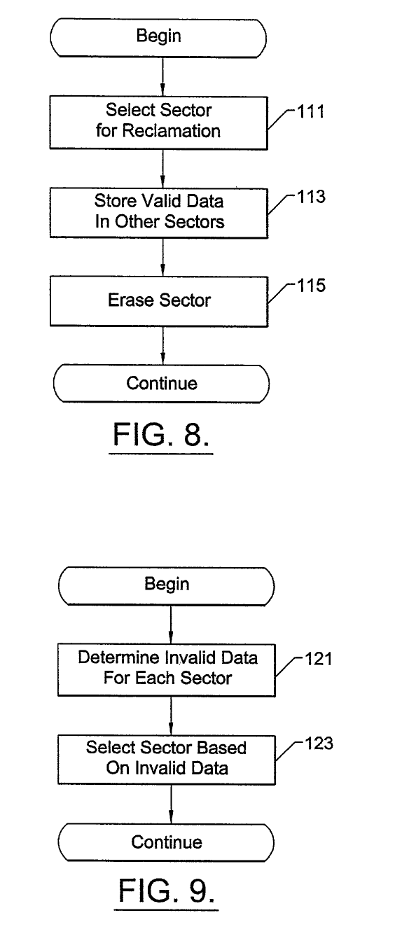

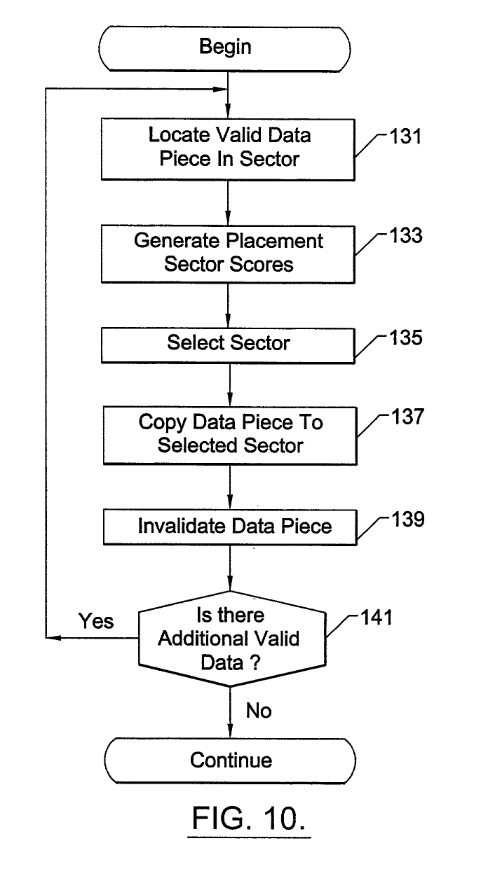

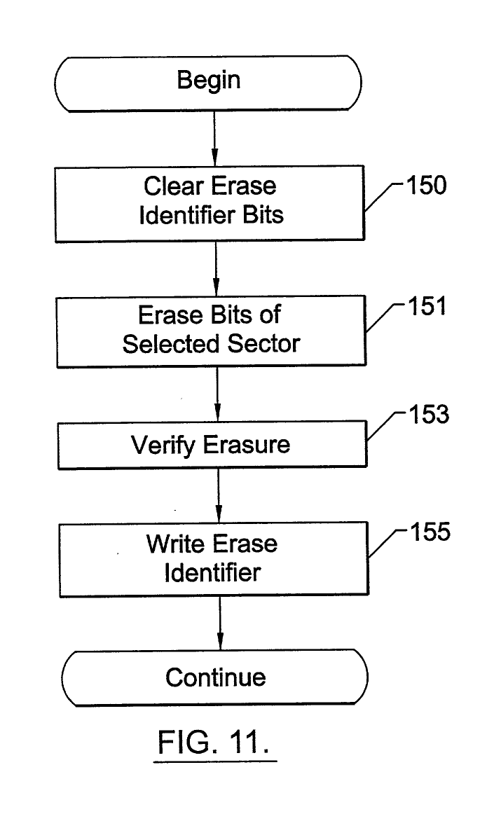

Examples of operations used to perform sector reclamation at block 45 of FIG. 3 are illustrated in FIG. 8. As shown, a sector can be selected at block 111, valid data from the selected sector stored in other sectors at block 113, and the selected sector erased at block 115. Examples of operations of selecting a sector for reclamation are illustrated in FIG. 9, examples of operations of storing valid data in other sectors are illustrated in FIG. 10, and examples of operations of erasing a sector are illustrated in FIG. 11.

As shown in FIG. 9, once a decision has been made to perform a sector reclamation operation, the memory controller can determine a number of bytes of invalid data stored in each of the sectors at block 121, and the sector with the largest ratio of number of bytes of invalid data stored therein to sector size can be selected for reclamation at block 123. By selecting a sector with more invalid data stored therein, the sector reclamation can provide more empty memory space after completion of the sector reclamation. The use of a ratio of invalid data to sector size provides that larger sectors are not reclaimed more frequently than smaller sectors. By way of example, performing sector reclamation on a sector with no invalid data would result in no additional empty memory space. As discussed above, invalid tagged data pieces in a sector can be identified by reading the valid bit (which will be cleared to zero for invalid data pieces), the data error bit (which will be at a logic high to indicate an invalid data piece0, and the header error bit (which will be at a logic high to indicate an invalid data piece) in each tagged data piece.

As shown in FIG. 10, the memory controller can locate each valid tagged data piece in the sector selected for reclamation and move each valid tagged data piece to another sector. A valid tagged data piece in the selected sector can be located at block 131 by scanning the selected sector. In particular, the memory controller may begin with the lowest address of the sector and determine if the first tagged data piece is valid based on the header error bit, the data error bit, the statistics error bit, and the valid bit of the STATUS field. If the tagged data piece is valid, a valid tagged data piece has been located. Otherwise, the memory controller can locate the next data piece using the error bits and/or the data size stored in the SIZE field of the first tagged data piece.

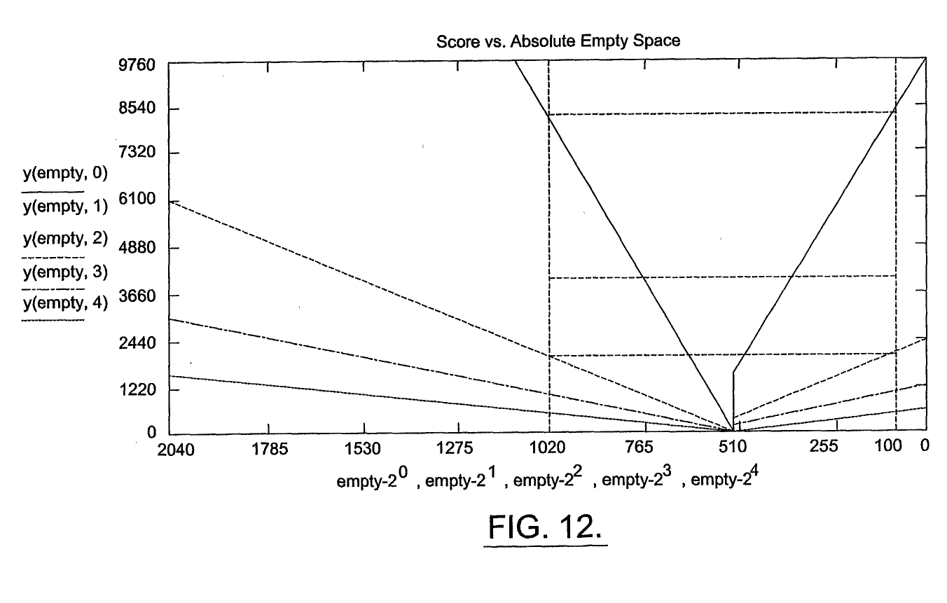

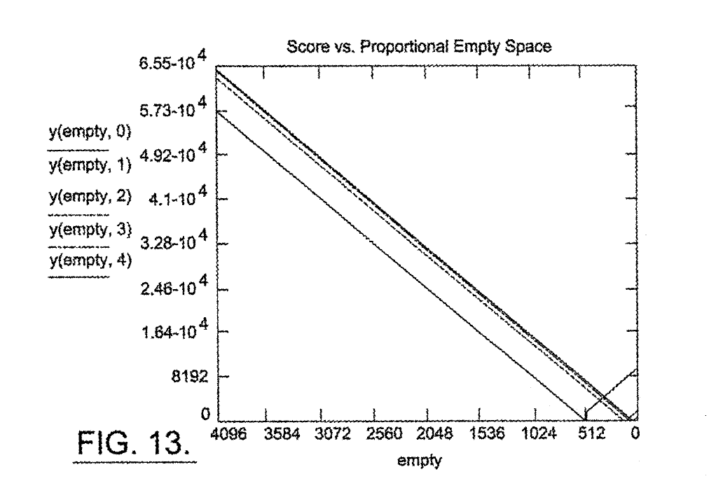

Once a valid tagged data piece is located at block 131, a placement score can be generated at block 133 for the valid tagged data piece for each sector other than the sector being reclaimed. The placement scores for each sector can be calculated using equations (3) and (4) provided below and these calculations can be illustrated in the graphs of FIGS. 12 and 13.

The sector with a suitable score for the valid tagged data piece can then be selected at block 135, and the valid tagged data piece can be written to the selected sector at block 137 using operations as discussed above, for example, with regard to FIG. 6. As shown below in equations (3) and (4) and the graphs of FIGS. 12 and 13, a suitable score can be the highest score. After writing the valid tagged data piece to the selected sector, the data piece can be invalidated in the sector being reclaimed by clearing the valid bit to zero at block 139. The process is repeated as long as there are additional valid tagged data pieces in the sector being reclaimed as shown at decision block 141.

In general, the reclamation placement score for a sector can increase with increasing empty space in the sector until the empty space for the sector is reduced to a predetermined amount (such as the MaxTagSize) beyond which the reclamation placement score for the sector may increase with reduced empty space and with increased size of the tagged data piece being moved. As with the normal placement score, the empty space may be calculated as a ratio with respect to the sector size so that larger sectors are not necessarily preferred with respect to smaller sectors.

As an example, the following formulas can be used to calculate reclamation placement scores y(empty, i) according to the present invention where i identifies the sector size with sector size being defined by Size(i)=4096(2^{j}) bits, where MaxTagSize=510 bytes, where empty is the number of empty bytes in the sector being scored, and where TagSize is the size of the tagged data piece being written in bytes. If empty(2^{j})>MaxTagSize, then the reclamation placement score for a sector can be calculated using:

y(empty, i)=(empty)(16)+(MaxTagSize)(2^{4-j}) Equation (3).

Otherwise, the reclamation placement score can be calculated using:

y(empty,i )=[MaxTagSize−[(empty)(2^{j})−TagSize]](2^{4-j}) Equation (4).

Graphical illustrations of reclamation placement scores are illustrated in FIGS. 12 and 13 for the placement of a tagged data piece having TagSize=100 bytes with MazTagSize=510 bytes for sectors having sizes of 4K (i=0), 8k (i=1), 16k (i=2), 32k (i=3), and 64k (i=4). FIG. 12 illustrates reclamation placement scores on the y axis with respect to available empty space normalized to sector size. FIG. 13 illustrates reclamation placement scores on the y axis with respect to absolute empty space on the x axis. In the calculations of the plots of FIGS. 12 and 13, the use of a shift operator may result in slightly different scores depending on the sector size so that the plots of different sectors are not the same. In the alternative, a divide operator may be used to provide more precise calculations.

As shown in both graphs, reclamation placement scores for a sector may decrease with reduced empty space until the remaining empty space of a sector approaches an amount of space needed to write a tagged data piece of the maximum tag size (MaxTagSize). At that point, reclamation placement scores for the sector may increase with decreased empty space available and increase with increasing TagSize (for a TagSize less than empty space) to try to pack a nearly full sector. By packing nearly full sectors, sufficient multiples of empty space can be maintained in other sectors to accommodate the movement of large tagged data pieces during reclamation. Without the packing of nearly full sectors during reclamation, there may be an increased risk of filling all sectors evenly in such a manner that no sector has enough empty space to write a tagged data piece of the maximum tag size (MaxTagSize).

As illustrated by the horizontal and vertical dashed lines of FIG. 12, a sector having less space will be preferred with respect to a sector having less than two maximum tag sizes of empty space (1020 bytes in the example of FIG. 12) so long as the data piece (100 bytes in the example of FIG. 12) being moved will fit. Accordingly, sufficient empty space can be maintained for the movement of final data pieces of the maximum tag size from the sector being reclaimed. Stated in other words, sufficient multiples of empty space of the maximum tag size can be maintained to facilitate movement of data pieces of the maximum tag size from the sector being reclaimed.

Once all of the valid tagged data pieces of the sector being reclaimed have been written to other sectors and invalidated in the sector being reclaimed, the memory controller can erase the sector being reclaimed at block 115 of FIG. 8. Examples of operations of erasing the sector are illustrated in the flow chart of FIG. 11. As shown, bits in which an erase identifier will be written can be cleared to logic 0 at block 150. The bits of the selected sector can then be erased to logic one at block 151. The memory controller can then verify proper erasure at block 153 and write an erase identifier at block 155. The erase identifier can be a unique two byte identifier, such as AAAA (hex) or 5555 (hex). The erase identifier, however, should preferably not be FFFF (hex), which would typically be present immediately after erasing the sector, or 0000 (hex), which would typically be present immediately after clearing all bits to zero.

The erase identifier can be written to the first two bytes of the erased sector to indicate successful erasure. The erase identifier may alternately be written to other portions of the sector that don't interfere with the data portion thereof. If a power failure occurs during an erase operation, the memory controller can determine on power up if the sector was successfully erased. If a power failure interrupts a sector erasure operation such that complete erasure is not obtained, the memory controller can proceed again with sector erasure operations until the sector is erased and ready to store new data pieces.

Tagged data pieces can be written to the memory device 31 as discussed above to provide efficient use of the memory device and to provide even use and erasure of sectors 31a-n within the memory device 31. By providing that each tagged data piece is written to a sector based on a placement score that is a ratio of empty sector space with respect to sector size, data can be written evenly to sectors of different sizes so that sectors of different sizes fill with valid data at similar rates. By making sector reclamation decisions after writing a tagged data piece, reclamation can be performed before attempting to write a tagged data piece that might otherwise not fit in available memory space. Moreover, by choosing a sector for reclamation based on a ratio of invalid space with respect to sector size, a greater amount of memory space can be freed while providing that sector reclamation is not biased toward larger sectors. Data storage, sector reclamation, and sector erasure techniques according to the present invention may, thus, provide wear leveling for the different sectors of a flash memory device so that device life can be increased and processing overhead can be reduced.

Once a valid tagged data piece is written to a sector of the memory device 31, the valid tagged data piece is available as tagged data until it is invalidated by the memory controller 33. In particular, a valid tagged data piece may become invalid when the data thereof is no longer correct or has changed. The processor, for example, may be a radiotelephone controller, and one tagged data piece may be used to store a list of control frequencies associated with a base station with which the radiotelephone is communicating. In this example, the control frequencies may change if the radiotelephone is moved to another location served by another base station having a different list of associated control frequencies. Accordingly, the memory controller may write a new tagged data piece with the new list of control frequencies, and invalidate the tagged data piece including the old list of control frequencies. As discussed above, the old tagged data piece can be invalidated by clearing the valid bit to zero.

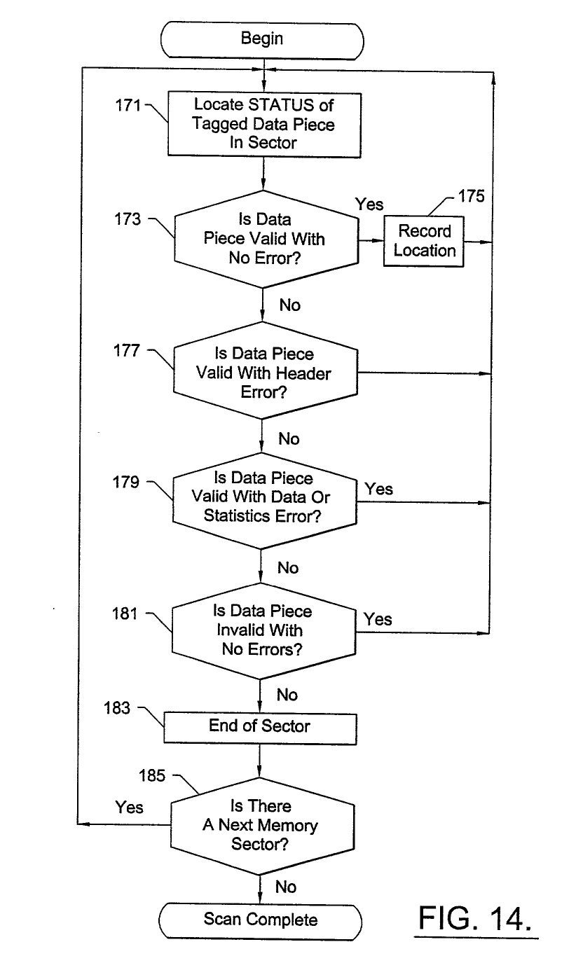

The memory controller can track the stored data by performing an initialization sequence when the processor is powered up. In particular, the memory controller can scan through each sector of the memory device and fill in pointers used to locate system data. Examples of operations used to scan the memory device on power up are illustrated in FIG. 14.

As shown in FIG. 14, the memory controller can locate the STATUS byte of a first tagged data piece in a first sector at block 171. If the STATUS byte indicates that the data piece is valid (valid bit at logic one) with no errors (header error bit, data error bit, and statistics error bit all at logic zero) at decision block 173, the memory controller can record the location of the valid tagged data piece at block 175 and proceed to locate the STATUS byte of the next tagged data piece in the sector. With a valid tagged data piece, the STATUS byte of the next tagged data piece can be located using the data size written in the SIZE field of the current data piece. If the memory controller determines that the valid tagged data piece has a duplicate TAGID of a previously recorded valid tagged data piece, the memory controller can select the most recently stored of the data pieces based on the information in the STATISTICS field. For example, a counter portion of the STATISTICS field may indicate the data piece that was most recently stored.

If the tagged data piece has a valid bit at logic one and a header error with the header error bit at one at decision block 177, the memory controller can proceed to locate the STATUS byte of the next tagged data piece. In this case, the STATUS byte of the next tagged data piece will be located following the header of the current tagged data piece because the header error indicates that no DATA field was written for the current tagged data piece. If the tagged data piece has a valid bit at logic one and a data error bit or statistics error bit at logic one at decision block 179, the memory controller can proceed to locate the STATUS byte of the next tagged data piece. In this case, the STATUS byte of the next tagged data piece will be located following the DATA field of the current tagged data piece, and the STATUS byte of the next tagged data piece can be located using the data size of the current data piece written in the SIZE field.

If the tagged data piece has a valid bit at logic zero indicating that the data piece is invalid at decision block 181, the memory controller can proceed to locate the STATUS byte of the next tagged data piece. In this case, the STATUS byte of the next tagged data piece will be located following the DATA field of the current tagged data piece, and the STATUS byte of the next tagged data piece can be located using the data size of the current data piece written in the SIZE field. If none of the decision blocks 173, 177, 179, or 181 result in a “Yes”, then the end of the sector has been reached at block 183 and the byte being analyzed will have a value of FF stored therein. In other words, the byte being analyzed has not been written to and is thus the first byte of empty memory available in the sector. In this case, the memory controller 33 can record the location of the beginning of empty memory in the sector and then determine if there is another sector to scan at decision block 185. If there is another sector to scan, the memory controller proceeds at block 171 with the scan of the next sector at block 171. Otherwise, the scan is complete.

The scanning operations illustrated in the flow chart of FIG. 14 can be used to locate each of the valid tagged data pieces stored in the memory device, and the memory controller 33 can save pointers to these valid tagged data pieces in associated dynamic memory 34, such as dynamic RAM. Accordingly, the memory controller can quickly locate data stored in the memory device 31. Moreover, the memory controller can update the pointers as additional tagged data pieces are written to the memory device 31, as tagged data pieces are invalidated or replaced, and as sector reclamation operations are performed.

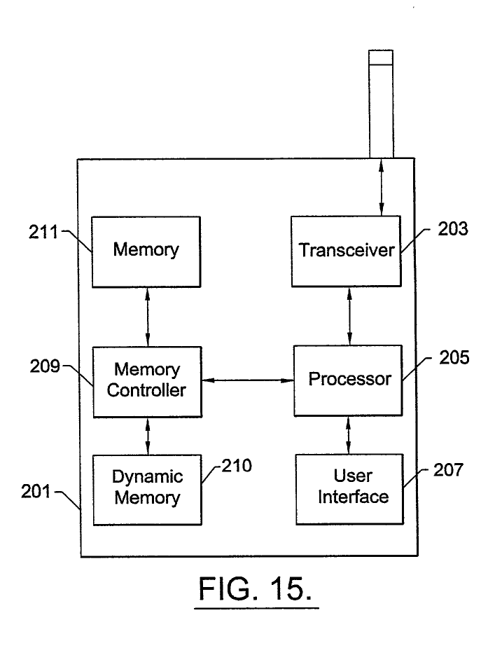

As discussed above with regard to FIG. 1, memory controllers and methods according to the present invention can be used together with known information processing systems. As a particular example, memory controllers can be used with mobile communications terminals as shown in FIG. 15. The mobile communications terminal 201 of FIG. 15 can include a transceiver 203 that transmits and/or receives communications over wireless channels; a processor 205 coupled to the transceiver that processes the communications transmitted and or received; a user interface 207 coupled with the processor that provides for user input and/or output; a memory controller 209 coupled with the processor; and a memory device 211 such as a non-volatile integrated circuit flash memory device coupled with the memory controller. The terminal 201 can also include dynamic memory 210 (such as dynamic random access memory) associated with the memory controller 209. The dynamic memory can be considered as separate from the memory controller or as being a part of the memory controller.

A flash memory device may typically be preferred for use in a mobile communications device because it is light, compact, rugged, and non-volatile. The memory controller 209 can thus read and write data from and to the flash memory 211 as needed by the mobile terminal processor. Moreover, the memory controller can operate as discussed above with respect to the memory controller 33. When used in the mobile communications device 201, the memory 211 can be used to store operating parameters such as control frequencies, system identification information, terminal identification information, user specified information (i.e. a telephone directory), etc.

According to additional aspects of the present invention, the memory controller 33 of FIG. 1 can perform a memory device initialization when all bytes of all sectors of the flash memory device 31 are erased to FF such as when the flash memory device is new and has not yet been programmed. In this situation, the memory controller 33 can write the predetermined erase identifier into the erase identifier bits of each sector of the memory device without taking time to erase the sectors because the device is in an erased condition when it is new. This operation may provide significant time savings when mass producing information processing systems 29 by reducing unnecessary erase operations.

Operations of memory device 31 initialization are illustrated in FIG. 16 wherein the memory controller can read the erase identifier bits of all sectors 31a-n of the memory device 31, at block 301. If all erase identifier bits of all sectors are erased to logic one (FF for a system with one byte of erase identifier bits for each sector) at decision block 303, the memory controller can proceed to write the predetermined erase identifier into the erase identifier bits of each sector 31a-n at block 305 without performing any sector erase operations. In this situation, the memory may assume that all bits of all sectors have been previously erased to one as is the case for a new flash memory device that has not been previously programmed. This operation may save time that might otherwise be spent reading all bits of all sectors to determine if all bits have been erased, and/or erasing all bits.

Otherwise, the memory controller 33 may erase all bits of all sectors at block 307 prior to writing the predetermined erase identifier into the erase identifier bits of each sector at block 305. The initialization operations of FIG. 16 can thus efficiently provide that all bits of the memory device are erased and that the erase identifier bits of each sector are programmed with the predetermined erase identifier.

According to additional embodiments of the present invention, a plurality of tagged data pieces can be used to store a collection of related data that might not fit in a single tagged data piece. A plurality of tagged data pieces making up a collection, for example, could be used to store a collection of related data for a file or a database. Accordingly, a size constraint on a tagged data piece need not limit a size of a collection of data that can be stored and retrieved according to aspects of the present invention.

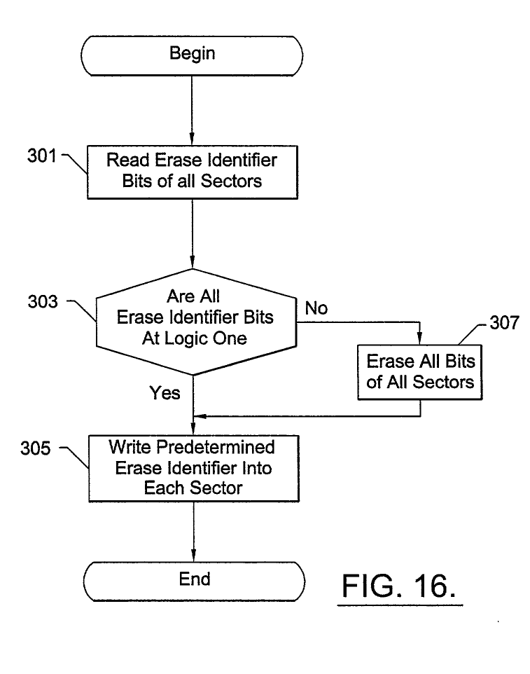

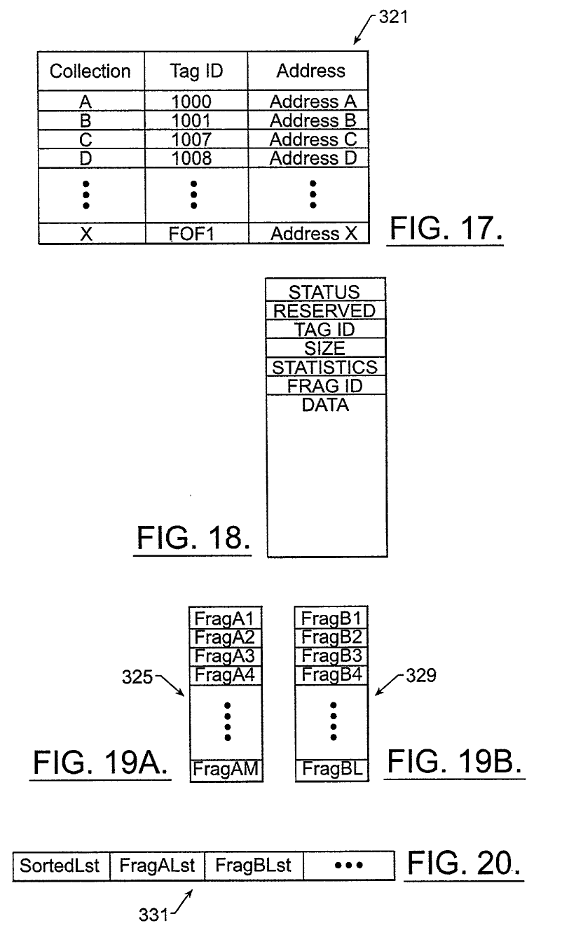

More particularly, a collection of related data can be stored in a collection of tagged data pieces where each tagged data piece of the collection includes a respective header (for example comprising a plurality of header bits) including a tag identification common to each of the tagged data pieces of the collection and a fragment identification unique to each of the tagged data pieces of the collection. With respect to the tagged data piece format illustrated in FIG. 18, the tag identification field TAG ID for each tagged data piece of a collection will include the same tag identification. When providing a collection of tagged data pieces, however, each tagged data piece of the collection can include a fragment identification in a fragment identification field FRAG ID that distinguishes each of the tagged data pieces of the collection. The additional fragment identification field, for example, can be provided as a previously unused portion of the statistics field STATISTICS discussed above with regard to FIG. 5.

The tagged data piece format of FIG. 18 can thus be the same as that of FIG. 5 with the exceptions that multiple tagged data pieces of a collection (also referred to as fragments of the collection) have the same tag identification, and that a fragment identification is provided in the fragment identification field FRAG ID where the fragment identification is unique for each tagged data piece of the collection. Accordingly, the mechanics for storing, retrieving, and maintaining fragments (i.e. tagged data pieces) of collections of tagged data pieces according to embodiments of the present invention can be the same as those discussed above with regard to FIGS. 1-16.

Moreover, each tagged data piece can be stored in consecutive memory cells of a non-volatile integrated circuit memory device 31 such as a flash memory device as discussed above with regard to FIGS. 1-16. Different tagged data pieces of the same collection, however, do not need to be stored in consecutively addressed memory cells of the memory device 31. More particularly, different tagged data pieces of the same collection can be stored in non-consecutively addressed memory cells of a memory device or even in different sectors of the memory device. Accordingly, at least one tagged data piece of a collection may be stored in memory cells not consecutive with respect to any of tagged data pieces of the same collection. Efficient storing, retrieving and maintaining of a relatively large collection of data can be provided in that the collection can be broken down into a collection of tagged data pieces each including a portion of the collection of data with each tagged data piece being stored and maintained, for example, as discussed above with regard to FIGS. 1-16.

A plurality of collections of related data can thus be stored in respective collections of tagged data pieces. For example, a first collection of related data can be stored in a first collection of tagged data pieces, and a second collection of tagged data pieces can be stored in a second collection of tagged data pieces. More particularly, each tagged data piece of the first collection can include a respective header including a first tag identification common to each of the tagged data pieces of the first collection and a fragment identification unique to each of the tagged data pieces of the first collection. Similarly, each tagged data piece of the second collection can include a respective header including a second tag identification (different than the first tag identification) common to each of the tagged data pieces of the second collection and a fragment identification unique to each of the tagged data pieces of the second collection.

Collections of tagged data pieces according to embodiments of the present invention can thus be used, for example, to store files, databases, and/or system directories in non-volatile integrated circuit memory such as flash memory. For example, collections of tagged data pieces according to embodiments could be used to store a database of names, telephone numbers, and addresses and/or files of operational data in flash memory of a portable electronic device such as a radiotelephone. This data can thus be saved when the radiotelephone is powered down and even when the battery is dead or removed. Moreover, the use of collections of tagged data pieces can provide efficient use of flash memory while also providing wear leveling among sectors of an integrated circuit flash memory device.

Methods and systems for identifying and retrieving collections of tagged data pieces will now be discussed in greater detail with reference to FIGS. 17-20. As discussed above, collections of related data can be stored in respective collections of tagged data pieces (also referred to as fragments) with each tagged data piece having a structure such as that illustrated in FIG. 18. In particular, each tagged data piece of a same collection includes the same tag identification in the respective TAG ID field and a different fragment identification in the respective FRAG ID field. Accordingly, all tagged data pieces of a collection in non-volatile memory 31 (such as illustrated in FIGS. 1 and 2) can be identified using the common tag identification, and each tagged data piece (fragment) within a collection can be distinguished using the respective fragment identification.

Each tagged data piece of a collection can thus have a fragment identification unique to that collection, and a same fragment identification (such as an initial fragment identification) can be used to identify an initial tagged data piece for each collection. For example, an initial tagged data piece for each collection can have a fragment identification of 0. In addition, an initial tagged data piece for a collection can include header information used to access the collection of tagged data pieces. For example, the initial tagged data piece can include the number of tagged data pieces in the collection. Accordingly, the initial data piece of the collection can be used to verify that the appropriate number of tagged data pieces of the collection are retrieved. According to embodiments of the present invention, the initial tagged data piece may not include actual data of the collection.

An information processing system 29, such as that illustrated in FIG. 1, can thus use the tag identifications and fragment identifications to retrieve collections from memory 31 for use as needed. According to embodiments of the present invention, a sorted list can be stored in dynamic memory 34 to identify and locate an initial tagged data piece of each collection. As shown in FIG. 17, a sorted list 321 can include the tag identification for each collection of data stored in the memory device 31, and an address in memory device 31 (pointer) for the initial tagged data piece of the collection. In the example of FIG. 17, each of the data collections A-X is identified with a respective Tag ID, and the sorted list includes the Tag ID for each collection and a corresponding address AddressA-AddressX for the initial memory cell address of the initial tagged data piece of the collection in non-volatile memory 31. Accordingly, the memory controller 33 can quickly locate the initial tagged data piece for any collection stored in the memory device 31. The sorted list 321 can be generated when the information processing system 29 is initialized and/or turned on.

A collection of related data does not need to be compiled from the respective collection of tagged data pieces until the collection of data is to be used by the processor 35. Once it is determined that a particular collection of data is to be compiled by the memory controller 33, a fragment list can be generated for the collection of data to be compiled. In particular, the memory controller 33 can use the Tag ID of the collection to be compiled together with the sorted list 321 to obtain the address in non-volatile memory 31 for the initial tagged data piece of the collection to be compiled. The memory controller 33 can also search the memory device 31 for all tagged data pieces having the Tag ID of the collection to be compiled. Once all tagged data pieces of the collection have been located in memory device 31, a fragment list 325 and/or 329 for the collection can be generated in dynamic memory 34 for the collection to facilitate access to the data of the collection as illustrated in FIGS. 19A and 19B.

When compiling a collection A of data as shown in FIGS. 17 and 19A, for example, each tagged data piece of collection A includes the same Tag ID 1000 stored in the respective TAG ID field, and each tagged data piece of collection A includes a unique fragment identification 0-M. Moreover, the initial tagged data piece (with fragment identification 0) of collection A can include the number of non-initial tagged data pieces (M) of the collection in data field DATA. As discussed above, the initial tagged data piece of the collection may include header information for the collection without including actual data of the collection. The memory controller 33 can thus generate a fragment list 325 for the collection A as shown in FIG. 19A where the fragment list includes an address FragA1-FragAM for each non-initial tagged data piece 1-M of the collection. The number of fragments stored in the initial tagged data piece, identified by fragment identification FragA0, can be used to verify that the fragment list for collection A is correct. The memory controller 33 can thus use the fragment list in dynamic memory 34 to quickly retrieve data of collection A from memory 31. A fragment list could also include an address for the initial tagged data piece, but this address may not be necessary.

A fragment list can be a linear sequential list of fragment addresses. There is no need to store a tag identification or fragment identifications in a fragment list because the tag identification was known when the fragment list was generated and is stored in the sorted list and because the fragments identifications are predefined (such as zero to the size of the collection stored in the initial tagged data piece). Accordingly, dynamic memory space can be conserved in that a fragment list need only store addresses for the respective non-initial tagged data pieces of the collection in order of fragment identification.

The fragment list of FIG. 19A for collection A can be maintained in dynamic memory 34 (such as dynamic random access memory) of the memory controller 33 as long as the data of collection A is to be used by the processor 35. Similarly, a second fragment list can be maintained in the dynamic memory 34 of the memory controller 33 for a second collection B of data with tag identification 1001 as shown in FIGS. 17 and 19B. The second fragment list includes an address FragB1-FragBL for each non-initial tagged data piece (1-L) of the second collection B. Each of the fragment lists for collections A and B can be maintained in dynamic memory of the memory controller as long as useful for the processor 35. For example, the memory controller can generate a respective fragment list responsive to a request from the processor 35, and the fragment list can be discarded when no longer being used to conserve dynamic memory. A given fragment list, for example, can be maintained until the processor 35 provides an indication that the fragment list should be discarded, and/or until a predetermined period of time has elapsed without accessing data of the collection, and/or until a number of fragment lists have been generated that exceeds some predetermined allocation of dynamic memory.

Any number of open fragment lists may be provided in dynamic memory 34 of the memory controller 33 at a given time. As illustrated in FIG. 20, an all list 331 in dynamic memory 34 of the memory controller 33 can be used to store dynamic memory addresses for the sorted list SortedLst 321 and fragment lists FragALst 325 and FragBLst 329 for open collections. In the example where fragment lists are opened in dynamic memory 34 for collections A and B as shown in FIGS. 19A and 19B, the all list 331 can include dynamic memory addresses for the sorted list 321 and each open fragment list 325 and 329. For each fragment list, the all list 331 can include the tag identification for the corresponding collection, the dynamic memory address of the fragment list, and a number of allocated entries in the fragment list. For example, the all list entry FragALst for collection A can include the tag identification 1000 for collection A, the dynamic memory address for fragment list 325 for collection A of FIG. 19A, and the number of allocated entries (M) for the fragment list 325 for collection A. Similarly, the all list entry FragBLst for collection B can include the tag identification 1001 for collection B, the dynamic memory address for fragment list 329 for collection B of FIG. 19B, and the number of allocated entries (L) for the fragment list 329 for collection B.

The all list 331 of FIG. 20 can include an entry for each fragment list opened in dynamic memory, with additional entries being added as fragment lists are opened corresponding to new data collections being accessed and with existing entries being deleted or set to NULL as fragments are deleted corresponding to data collections no longer being used. The sorted, fragment, and all lists can thus be used to efficiently locate and use data collections stored in non-volatile memory 31 as discussed in greater detail below.

A sorted list can be generated by the memory controller 33 in dynamic memory 34 when the information processing system 29 is turned on and/or initialized. More particularly, the sorted list 321 can be generated by scanning the memory device 31 for all tagged data pieces having the initial fragment identification such as an initial fragment identification of zero. For each tagged data piece having the initial fragment identification, the tag identification is entered into the sorted list along with the non-volatile memory address (pointer) for the tagged data piece. Once all tagged data pieces with an initial fragment identification have been located and added to the sorted list, entries can be sorted by tag identification as shown in FIG. 17. Sorting by tag identification may be useful because a scan of the memory device 31 may not locate tagged data pieces in any particular order, so that sorting may provide for more efficient searching of the sorted list. The initial tagged data piece for each collection can thus be located relatively quickly using known means, such as linear or binary searches or other known search mechanisms, for searching a sorted list.

Once the information processing system has been turned on or initialized, collections of data may be added to the memory device 31 or deleted from the memory device 31. If a collection of data is added to the memory device, the tag identification and memory address for the initial tagged data piece for the collection can be added to the sorted list. If a collection of data is made obsolete or removed from the memory device 31, the tag identification and memory address for the initial tagged data piece can be removed from the sorted list. If a memory sector is reclaimed such that the location of an initial tagged data piece for an existing collection is changed, the address (pointer) in the sorted list can also be changed to reflect the new address.

As shown in FIG. 17, there may be gaps in the sequential listing of tag identifications in the sorted list. For example, collection B is allocated tag identification 1001 and collection C is allocated tag identification 1007. Some of the intervening tag identifications 1002-1006 may be used for tagged data pieces that are not a part of a collection as discussed above with regard to FIGS. 1-16, and others of the intervening tag identifications 1002-1006 may have been allocated to tagged data pieces and/or collections that have since been invalidated and/or erased from memory device 31. When a new collection of tagged data pieces is stored in memory device 31, the corresponding tag identification and address are stored in the sorted list with the tag identification being inserted in numerical order with respect to the existing tag identifications.

When the sorted list of FIG. 17 is initially generated, a predetermined amount of dynamic memory can be allocated to the sorted list. As collections of data are stored in memory device 31, a new sorted list may need to be generated with a greater amount of dynamic memory allocated thereto. Alternately, a new sorted list may be generated with a lesser amount of dynamic memory allocated thereto if collections of data are invalidated and/or removed from the memory device 31.

When it is desired to use a collection of data stored as a collection of tagged data pieces, a fragment list for the collection can be generated by the memory controller 33 in dynamic memory 34 of the memory controller 33 as illustrated in FIGS. 19A and 19B. The memory controller can first search the sorted list for the tag identification of the collection to be compiled, and the corresponding address can be used to locate the initial tagged data piece of the collection to be compiled. As discussed above, the data field DATA of the initial tagged data piece can include a number of tagged data pieces in the collection, such as the number of tagged data pieces in the collection other than the initial tagged data piece, or alternatively, the total number of tagged data pieces in the collection.

The number of non-initial tagged data pieces in the collection can then be used to allocate a portion of dynamic memory for a fragment list for the collection. All allocated fragment list entries can be initialized to NULL to indicate an absence of the fragment's address in memory device 31. A scan of the memory device 31 can then be performed to locate all tagged data pieces of the collection other than the initial tagged data piece. If the initial fragment identification is zero, for example, the memory device can be scanned for tagged data pieces having the tag identification for the collection and having non-zero fragment identifications. The initial tagged data piece does not need to be located because the address for the initial tagged data piece is provided in the sorted list.

The fragment list can then be generated by storing the address for each tagged data piece for the collection. A fragment list can include the address for all tagged data pieces of a collection including the initial tagged data piece. As shown in FIGS. 19A and 19B, however, the address for the initial tagged data piece of the collection may not need to be included in the fragment list because the address for the initial tagged data piece is provided in the sorted list, and/or because the initial tagged data piece may include only “header” information used to build the fragment list and not actual data of the collection. If tagged data pieces are found outside the range of the collection as indicated by the initial tagged data piece, the fragment list can be reallocated to provide additional space.

The address for each tagged data piece of the collection is then entered into the fragment list in order of corresponding fragment identification. When completed, the fragment list will include the addresses of all fragments found (possibly excepting the address of the initial tagged data piece) in order of fragment identification, and with NULL entries for the address of any tagged data pieces not found.

When a tagged data piece of a collection with a corresponding fragment list saved, is relocated as a result of sector reclamation, or is updated with new data, the new memory device address for the tagged data piece is entered into the fragment list (in place of the old memory device address for the fragment) in fragment identification order. The fragment list can be maintained in dynamic memory of the memory controller 33 as long as the data collection corresponding to the fragment list is being used by the processor 35. Once the data collection is no longer being used or is not expected to be used in the near future, the fragment list for the data collection can be de-allocated or removed from dynamic memory 34.

An all list 331, such as that illustrated in FIG. 20, can be provided in dynamic memory of the memory controller 33 to keep track of the sorted list and multiple fragment lists. For each fragment list that is being maintained in dynamic memory, the all list includes the tag identification for the collection of tagged data pieces, the dynamic memory address for the fragment list, and the number of allocated entries in the fragment list as well as any additional tracking information that may be desired. When data of a collection is to be retrieved, the corresponding tag identification can be located in the all list 331, and the corresponding dynamic memory address can be used to locate the fragment list for the collection. The fragment list can then be used to provide the memory address of the desired tagged data piece in memory device 31.

A pointer for the all list 331 of FIG. 20 can also be maintained to identify the last fragment list accessed by the memory controller. If the memory controller has last accessed data collection B, the pointer can be used to identify the location of FragBLst in the all list. If the next request for a data collection is for data collection B, the memory controller 33 can quickly locate the fragment list for data collection B using the pointer and the all list 331. Otherwise, the memory controller can search the all list for the tag identification for the data collection to be accessed. If a fragment list for the data collection is currently open, the search of the all list by tag identification will allow the memory controller to quickly locate the dynamic memory address of the corresponding fragment list. If a fragment list for the data collection is not currently open, the tag identification will not be located in the all list. Accordingly, the memory controller can get the address for the sorted list from the all list, locate the tag identification in the sorted list, and then generate a fragment list for the desired data collection.

In other words, the pointer and the all list can be used to quickly locate open fragment lists for previously compiled data collections and/or to generate a fragment list if a fragment list is not currently opened. When data of a collection is to be retrieved, the memory controller can first check the last accessed tag identification designated by the all list pointer. Because a data collection may be accessed repeatedly, there is a relatively high probability that the last accessed data collection may be the same as the data collection to be accessed. Accordingly, access time may be saved by first checking the last accessed data collection. If the tag identification of the last accessed data collection matches the tag identification of the data collection to be accessed, the memory controller can use the corresponding dynamic memory address to locate the appropriate fragment list.

If the tag identification of the last accessed data collection does not match the tag identification of the data collection to be accessed, the memory controller can search the all list for a matching tag identification. If a match is found, the corresponding dynamic memory address can be used to locate the appropriate fragment list. In other words, all open fragment lists are identified in the all list, and the use of an open fragment list can save the time needed to generate a fragment list.

If the tag identification of the data collection to be accessed does not match the tag identification of any tag identification in the all list, the memory controller can use the all list to obtain the address of the sorted list. The sorted list can then be used to generate a fragment list for the data collection to be accessed. Accordingly, a new fragment list is generated only after determining that a fragment list for the data collection to be accessed is not already open.

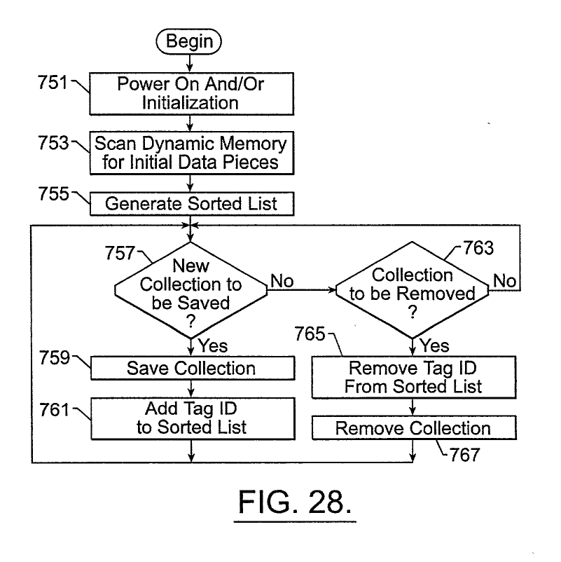

Operations for tracking collections of tagged data pieces are illustrated in the flow charts of FIGS. 28-30. As shown in FIG. 28, when the power is turned on or the information processing system is otherwise initialized at block 751, a scan of non-volatile memory for initial tagged data pieces can be performed at block 753. The results of the scan can be used to generate a sorted list, at block 755, of tag identifications for collections of tagged data pieces identified in the scan. If a new collection of data is to be saved in non-volatile memory at block 757, the collection of data is saved as a collection of tagged data pieces at block 759 and the tag identification for the new collection is added to the sorted list at block 761. If an existing collection of tagged data pieces is to be removed from non-volatile memory at block 763, the tag identification for the collection is removed from the sorted list at block 765, and the collection is then removed from non-volatile memory at block 767.

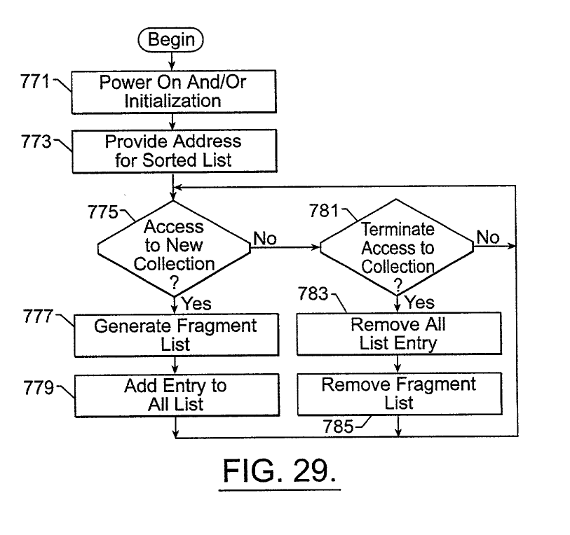

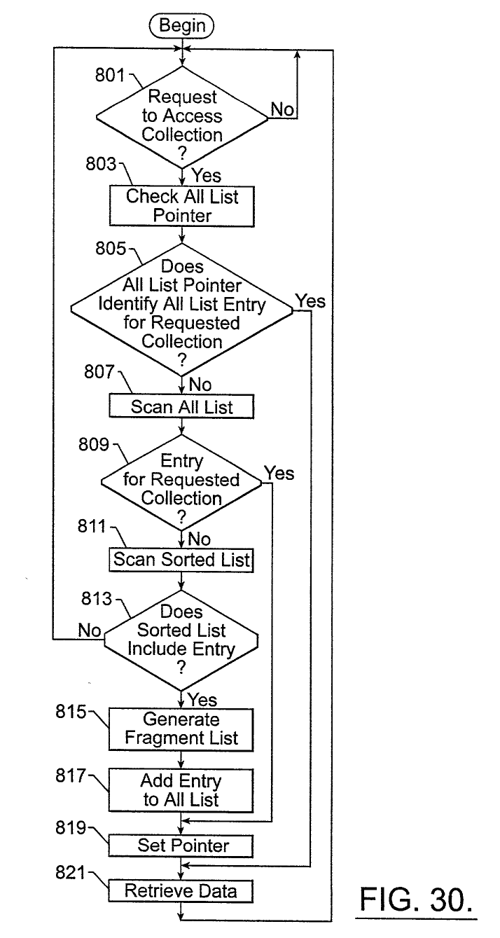

An all list can be provided according to embodiments of the present invention as shown in FIG. 29. When power is turned on or the information processing system is otherwise initialized at block 771, an address in dynamic memory for the sorted list is provided in the all list at block 773. If access to a previously unused collection is requested at block 775, a fragment list for the collection can be generated in dynamic memory at block 777, and an entry for the collection can be added to the all list at block 779. If access to a currently available collection is to be terminated at block 781, the all list entry for the collection can be removed at block 783, and the fragment list can be removed from dynamic memory at block 785. If access to the collection of tagged data pieces is removed at blocks 781, 783, and 785, the collection of tagged data pieces is still maintained in non-volatile memory, and access can be regained through operations of blocks 775, 777, and 779.

A collection of tagged data pieces can be located according to embodiments of the present invention using sorted and all lists as discussed below with reference to FIG. 30. If access to a collection is requested at block 801, the memory controller can first check the all list pointer at block 803, and if the all list pointer identifies an all list entry corresponding to the requested collection at block 805, the data can be retrieved at block 821. If the all list pointer does not identify an all list entry corresponding to the requested collection at block 805, the all list can be scanned at block 807. If an entry in the all list corresponds to the requested collection at block 809, the all list pointer can be set to the entry corresponding to the requested collection at block 819, and the data can be retrieved at block 821. If the all list does not include an entry for the requested collection at block 809, the sorted list can be scanned at block 811. If an entry in the sorted list corresponds to the requested collection at block 813, a fragment list for the requested collection can be generated at block 815, an entry for the requested collection can be added to the all list at block 817, the all list pointer can be set to the new all list entry at block 819, and the data can be retrieved at block 821. Because a collection may be accessed repeatedly, access times can be reduced by first checking the all list pointer that identifies the last accessed collection and then scanning the all list that identifies a plurality of the most recently accessed collections before scanning the sorted list of all collections.

According to additional embodiments of the present invention, a directory system can be stored in non-volatile memory as a collection of data using collections of tagged data pieces as discussed above with reference to FIGS. 17-20. In particular, each tagged data piece of a directory system collection can be provided according to the format illustrated in FIG. 18. All tagged data pieces of a directory system collection can thus be identified using the same tag identification, and distinguished using different fragment identifications. Moreover, a directory system collection can include a root directory and subdirectories, and each directory and subdirectory of the directory system can include identifications of subdirectories, files, and/or databases.

A system directory can thus be provided in non-volatile integrated circuit memory such as flash memory using collections of tagged data pieces according to embodiments of the present invention. For example, a first plurality of entry identifications can be stored as a first tagged data piece including a tag identification for the system directory and a first fragment identification. A second plurality of entry identifications can be stored in a second tagged data piece including the tag identification for the system directory and a second fragment identification different than the first fragment identification. A system directory of variable length can thus be maintained in flash memory of a portable electronic device such as a radiotelephone even when the battery is dead or removed.

As with collections of tagged data pieces for data collections discussed above, the data field DATA of an initial tagged data piece of a directory system collection can include information used to compile the directory system without including actual identifications of subdirectories, files, and/or databases. As before, the initial tagged data piece of a system directory collection can be identified with an initial fragment identification such as zero. More particularly, the data field of the initial tagged data piece can include volume attributes of the directory system collection such as the volume name, a number of fragments used in the directory system collection, a next fragment identification to be assigned, and a next tag identification to be assigned to an element. Accordingly, the initial tagged data piece can include information used to compile the system directory, to add/delete entries to/from the system directory, and/or add/delete tagged data pieces to/from the system directory collection.

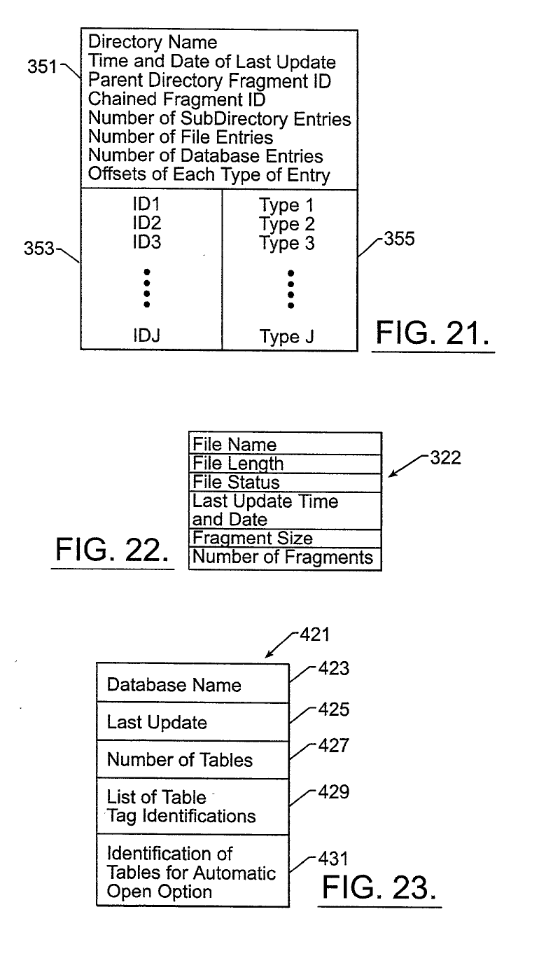

The data field DATA of a non-initial tagged data piece of the system directory collection can include header information and identifications of subdirectories, files, and/or databases. An example of information stored in the data field DATA of a non-initial tagged data piece of a system directory is illustrated in FIG. 21. As shown in FIG. 21, the data field of a non-initial tagged data piece of a system directory collection can include header information 351, entry identification information 353, and corresponding entry type information 355.

The header information can include the directory name (or subdirectory name), a time and date of a last update of the directory, a parent directory fragment identification, a chained fragment identification, a number of subdirectory entries in the tagged data piece, a number of file entries in the tagged data piece, and a number of database directories in the tagged data piece. The header information can also include offsets of each type of entry in the lists of entries provided in the tagged data piece. As shown in columnar form, the header information 351 can be followed by the entry identification information 353 and corresponding entry type information 355. In the example of FIG. 21, the tagged data piece can include J directory entries with two byte entry identifications ID1 to IDJ and corresponding two byte entry types Type1 to TypeJ.

By way of example, each entry type may be one of a directory type (DIR), a file type (FILE), or a database type (DBASE). The entry identification for a file type or a database type entry can be a tag identification for a collection of tagged data pieces (other than the tag identification for the system directory collection) making up the respective file or database. The entry identification of a directory type entry can be a fragment identification of a tagged data piece of the subdirectory within the directory system collection. A directory according to embodiments of the present invention can thus be used to locate files, databases, and/or subdirectories stored in non-volatile memory 31 such as flash memory. Moreover, system directory collections according to embodiments of the present invention can be stored in non-volatile memory 31 using techniques as discussed above with regard to FIGS. 1-20.

A system directory collection according to embodiments of the present invention can include a root directory stored in one or more non-initial tagged data pieces and one or more subdirectories each stored in one or more non-initial tagged data pieces. Each non-initial tagged data piece of the system directory collection can have the format illustrated in FIG. 21. Because there may be a limit to the number of entries allowed in a single tagged data piece of the system directory collection, a single directory may be saved in multiple tagged data pieces of the format illustrated in FIG. 21.

An initial tagged data piece of the directory system collection may have a fragment identification of zero and may include information used to compile the directory system without including actual identifications of subdirectories, files, and/or databases. A root directory according to embodiments of the present invention may begin in the next tagged data piece of the collection having a fragment identification of one. As long as a predetermined number of entries in the root directory is not exceeded, the root directory may be included in a single tagged data piece having the fragment identification of one. In this situation, the parent directory fragment identification will be the fragment identification of one because the root directory does not have a parent directory. In other words, the root directory may list it's own fragment identification as the parent directory fragment identification. The chained fragment identification may also be one because there are no additional tagged data pieces making up the root directory.

If the number of entries of the root directory exceeds the predetermined number allowed in a single tagged data piece, an additional tagged data piece can be used to store the additional entries. Each tagged data piece of the root directory (as well as tagged data pieces of subdirectories) will have a common format such as that illustrated in FIG. 21. Moreover, multiple tagged data pieces of the root directory (or multiple tagged data pieces of a subdirectory) may have consecutive fragment identifications. Alternately, multiple tagged data pieces of a directory may have non-consecutive fragment identifications so that a directory or subdirectory can be lengthened after the system directory collection has been initially set up.

With respect to a root directory stored in multiple tagged data pieces, the first tagged data piece stored in fragment one may have a chained fragment identification equal to the fragment identification of the second tagged data piece of the root directory. Each successive tagged data piece of the root directory will have a chained fragment identification equal to the fragment identification of the next tagged data piece of the root directory, with the exception that the last tagged data piece of the root directory can have a terminal identifier, such as a chained fragment identification equal to its own fragment identification. Accordingly, the root directory can be compiled by opening fragment one of the system directory collection, and using the chained fragment identifications of fragment one and each subsequently identified fragment of the root directory to open all tagged data pieces of the root directory. The last tagged data piece of the root directory will be self evident because the chained fragment identification of the last tagged data piece will not provide a fragment identification of a subsequent tagged data piece but will instead provide a terminal identifier such as its own fragment identification.

The root directory can then be used to locate and compile subdirectories identified therein. Each subdirectory identified in the root directory will have the DIR entry type identified corresponding to a fragment identification corresponding to the first fragment of the subdirectory. Accordingly, a first tagged data piece of each subdirectory identified in the root directory can be located within the system directory collection using fragment identification provided in the root directory.

Moreover, each tagged data piece of each subdirectory can have the same format as tagged data pieces of the root directory such as the format illustrated in FIG. 21. Accordingly, the chained fragment identification of the first tagged data piece of the subdirectory can be used to locate additional tagged data pieces of the subdirectory. Once the first tagged data piece of a subdirectory has been located, the entire subdirectory can be compiled using the chained fragment identification as discussed above with regard to the root directory. Like the root directory, a subdirectory can identify files, databases, and/or more subdirectories. A tree directory structure can thus be provided with pluralities of levels of subdirectories emanating from a single root directory.

Once a directory system collection has been saved in non-volatile memory, additional entries may be added to the root directory or a subdirectory. For example, a file, database, or even a new subdirectory may be saved in memory resulting in the addition of an entry to a directory such as the root directory or a subdirectory. If the directory to which the addition is to be made has additional space in the last tagged data piece thereof, the entry can be made to the directory without the allocation of an additional tagged data piece to the directory. In this case, the entry is made, and each of the tagged data pieces of the directory is updated to reflect the time and data of this most recent update.

In the event that there is no additional space in the last tagged data piece of the directory, an additional tagged data piece can be allocated to the directory, and the chained fragment identification of the previous last tagged data piece of the directory can be updated to the fragment identification of the new tagged data piece of the directory. The new tagged data piece of the directory will include header information consistent with the directory to which it has been added, and identification and type entries for the new entry. The chained fragment identification of the new tagged data piece will be the fragment identification of the new tagged data piece or another terminal identifier. Accordingly, a directory can grow as any number of entries is added to it. A directory system collection as discussed above can thus be used to organize and locate information stored in non-volatile memory in an efficient manner.

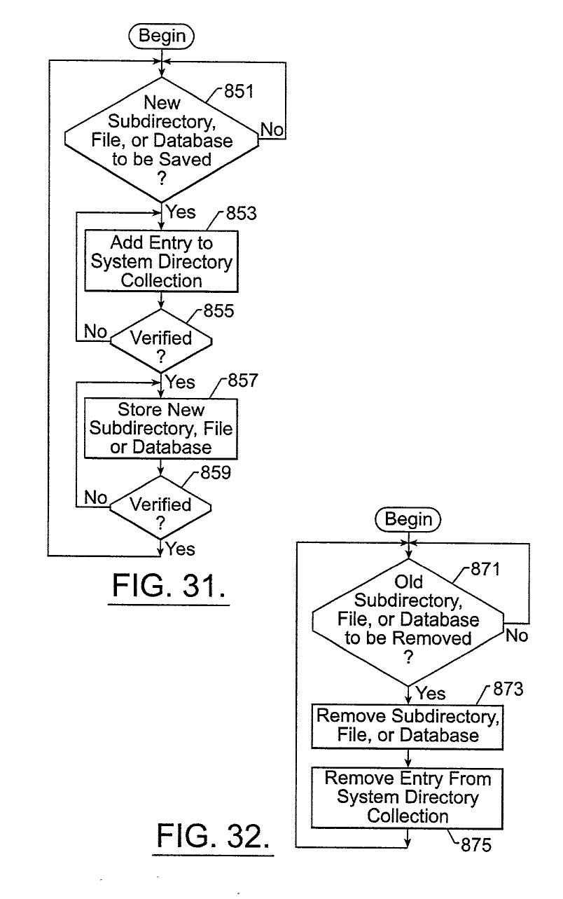

A system directory collection according to embodiments can be built beginning with the root directory in the first non-initial tagged data piece of the collection, such as a tagged data pieced having the fragment identification of 1. The system directory collection can then be grown from the root directory to reduce the impact of power loss while storing or updating the system directory collection. As shown in FIG. 31, when a new subdirectory, file, or database is to be stored in the non-volatile memory device at block 851, the entry for the new subdirectory, file, or database can be added to the appropriate tagged data piece of the system directory collection at block 853 and verified in non-volatile memory before the new subdirectory, file, or database is created at block 855. Once the entry to the system directory collection has been verified in non-volatile memory, the new subdirectory, file, or database can be stored at block 857, and correct storage of the subdirectory, file, or database can be verified at block 859. Similarly, the file system may create its files by first storing the header information before storing any data in the file.

Accordingly, a loss of power when creating a system directory entry for a new subdirectory, file, or database is less likely to result in a disconnected system. In other words, a power loss may result in a directory entry with no corresponding subdirectory, file, or database, in which case, the directory entry can be removed. A power loss, however, is not likely to result in the creation of a subdirectory, file, or database that does not have a corresponding entry in the system directory collection.

When a subdirectory, file, or database with a corresponding entry in the system directory collection is removed from memory, the reverse action is taken. As shown in FIG. 32, if a file, or database is to be removed at block 871, each tagged data piece of the collection is removed at block 873, and then the directory entry for the file or database is removed from the system directory collection at block 875. If a subdirectory is removed, each identified file, database, and subdirectory is removed from memory; then each entry identification and corresponding entry type is removed from the subdirectory; then each header is removed from the subdirectory; and then the entry for the removed subdirectory is removed from its parent directory.

When a directory is to be searched for a specific collection of data, a current directory may or may not have a list of collections of the type sought. Any entries of the associated type can be located in non-volatile memory using the entry identifications, and the information in that entry's header information can be compared against the search criteria. In other words, the directory can be used to locate all collections of tagged data pieces of the type (for example files or databases) being searched, and information in the located collections can be used to identify each of the collections. The system directory, however, does not need to provide titles or names of the collections for the comparison.

When a match for the specific collection is found from the collections identified in the directory, the match is reported to the system directory, and the matching two-byte entry identification (fragment identification for a subdirectory or tag identification for a file or database) is returned to the client application which owns the type of element sought. Once the client application receives the identity of the element it was seeking, the client application may act on the collection or subdirectory as appropriate.

As discussed above with regard to FIGS. 17-20, a collection of data can be stored in non-volatile memory using a collection of tagged data pieces to allow storage of data exceeding a predetermined size of an individual tagged data piece. Multiple tagged data pieces of the format illustrated in FIG. 18, for example, can be used to store a collection of data such as a file or a data base or a system directory where each tagged data piece of the collection has a same tag identification and a different fragment identification. Moreover, an initial tagged data piece of a collection can be used to store information used to access the collection such as a number of non-initial tagged data pieces of the collection, and non-initial tagged data pieces can be used to store the actual data of the collection.

According to additional embodiments of the present invention, an initial tagged data piece of a collection can have an initial fragment identification such as zero, and subsequent fragments of the collection can have sequential fragment identification numbers. In addition, the data field DATA of the initial tagged data piece can include file attributes in addition to the number of fragments included in the collection. As illustrated in FIG. 22, the data field 322 of the initial tagged data piece can include attributes such as a file name for the collection, a file length for the collection, a file status for the collection, a last update time and date of the collection, a fragment size used for all tagged data pieces belonging to the collection, and a number of fragments belonging to the file. The data field of the initial tagged data piece of the collection according to embodiments illustrated in FIG. 22, however, does not include actual data of the collection. Instead, the data field of the initial tagged data piece illustrated in FIG. 22 can be used to read, write, delete, and otherwise access data of the collection stored in non-volatile memory.

Data fields of non-initial tagged data pieces of the collection can include data of the collection stored in a sequential manner starting with fragment 1 at byte 0 of the data field. According to embodiments of the present invention, each tagged data piece of a collection may have a fixed data field size of 512 bytes. According to such an implementation, for example, the byte located at file position 1124 of the collection of data (i.e. the 1124^{th} byte of the collection of data) would be located in the tagged data piece with fragment identification equal to 3 at a byte offset of 99 in the data field thereof. Tagged data pieces of a different collection, however, may have a different fixed data field size. The tagged data pieces can be stored in non-volatile memory using any means supported by the non-volatile memory, such as those discussed above with regard to FIGS. 1-21. Accordingly, the information processing system can use the information provided in the initial tagged data piece to locate specific bytes of the data collection by fragment identification of the specific tagged data piece of the collection and by location offset within the specific tagged data piece.

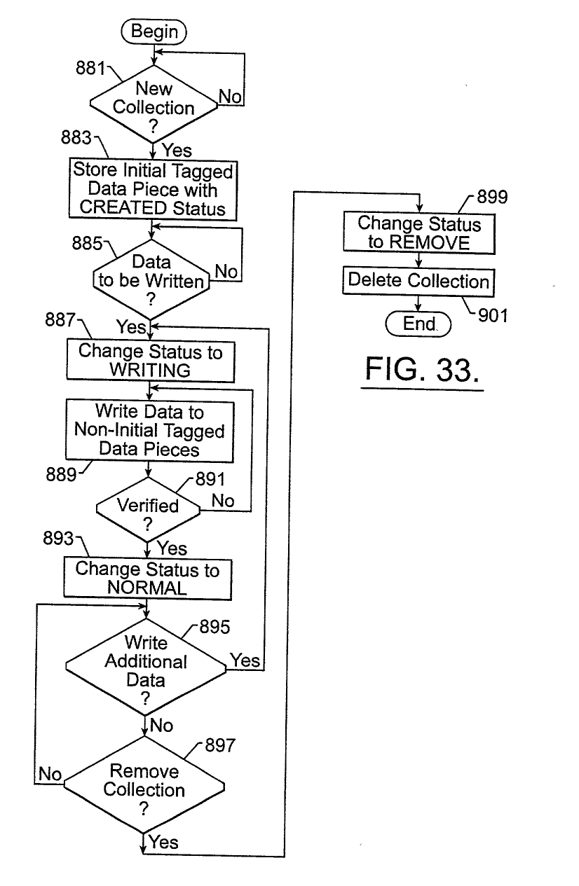

According to embodiments of the present invention illustrated in FIG. 22, the collection of tagged data pieces can be in one of the following states: CREATED, NORMAL, WRITING, or REMOVING. The file status of the initial tagged data piece of the collection will thus indicate the present state of the collection as either CREATED, NORMAL, WRITING, or REMOVING as illustrated in FIG. 33.

A CREATED file does not contain data of the collection and will remain in this state until data of the collection is to be written to the non-volatile memory. As shown in FIG. 32, when a new collection of data is to be stored at block 881, a collection of tagged data pieces can be created, for example, prior to actually storing the corresponding collection of data so that the information processing system will be ready to store the collection of data when available. A created file may result in the storing of a collection of tagged data pieces including the initial tagged data piece with a status of CREATED at block 883. A created file may also include one or more non-initial tagged data pieces with no data stored in the respective data fields thereof wherein the tagged data pieces of the collection have the same tag identification and different fragment identifications.

When data of the collection is to be written to the collection of tagged data pieces in non-volatile memory at block 885, the file status in the initial tagged data piece of the collection is changed to WRITING at block 887, and data is written to non-initial tagged data pieces of the collection at block 889. Once data is written to data fields of non-initial tagged data pieces of the collection and verified at block 891, the file status in the initial tagged data piece of the collection is changed to NORMAL at block 893. If additional data is to be written at block 895, the operations of blocks 887, 889, 891, and 893 can be repeated. When the collection of data is to be removed from non-volatile memory at block 897, the file status in the initial tagged data piece of the collection is changed to REMOVING at block 899, and the collection is removed or deleted at block 901. The file status in the initial tagged data piece of the collection can thus be used in the event of power failure during writing or removing steps to recover on power up.

If power is lost when writing data to a collection of tagged data pieces, the collection of tagged data pieces may be considered corrupted because it may not be possible on initialization after the power failure to know which data was written and which data was not written. Upon initialization, any collection of tagged data pieces with a file status of WRITING can thus be removed from non-volatile memory, or a re-validation procedure can be performed on the affected collection, after which the file status can be set back to NORMAL.

Because some data may be irreplaceable if corrupted by a power loss while in the writing state, a new list of copied numbered tagged data pieces can be kept in flash memory which could effectively backup any affected portions of the file. Accordingly, when a corrupt file is detected, the list of tagged data piece copies can be used to restore the file back to its prior non-corrupt NORMAL state and the file status can be updated accordingly. In other words, a backup file can be created in non-volatile memory before writing to a collection of tagged data pieces, and the back up file can be used to restore the collection of tagged data pieces in the event that the collection is corrupted by a power failure during writing.

If a collection of tagged data pieces is either corrupted or obsolete, the collection can be removed to free memory space in the non-volatile memory. Before removing a collection of tagged data pieces, the file status in the initial tagged data piece of the collection can be set to REMOVING to indicate that the collection is being removed. If power is lost while a collection is being removed, the REMOVING status will indicate that the collection is to be removed when the information processing system is reinitialized. Upon initialization, the memory controller can proceed with removing any collections having the REMOVING status. A collection of tagged data pieces can be removed from non-volatile memory by removing or invalidating the tagged data pieces of the collection using any means supported by the non-volatile memory. When removing a collection of tagged data pieces, the initial tagged data piece is not removed until all non-initial tagged data pieces are removed so that the REMOVING status will be provided in the event of power failure.

According to embodiments of the present invention illustrated in FIG. 22, write operations can be used to write data of the collection in one or more tagged data pieces of the collection. Moreover, write operations can be performed for a collection of tagged data pieces where data of the collection is written to a tagged data piece having a fragment identification that is more than one fragment identification number greater than the highest fragment identification number for a tagged data piece previously stored in the collection. Stated in other words, a client application may set a file location to a location beyond the currently stored end of the file to initiate writing from that file position to even higher file locations. Fragment identifications may thus be skipped so that the collection of tagged data pieces does not include tagged data pieces for unwritten portions of the file, thereby saving space in the non-volatile memory.

When fragment identifications are skipped in a collection of tagged data pieces, the number of fragments portion of the data field of the initial tagged data piece can be updated to reflect the new file length including intermediate tagged data pieces that have not been written into non-volatile memory. Similarly, the fragment list (such as illustrated in FIGS. 19A and 19B) for the collection can include entries for all fragment identifications including intermediate fragment identifications for tagged data pieces that have not been written to non-volatile memory. Entries for fragment identifications that have not been written to non-volatile memory, however, can include a NULL entry to indicate an unwritten tagged data piece as opposed to a pointer to a non-volatile memory address for a tagged data piece that has been written to non-volatile memory.

According to further embodiments illustrated in FIG. 22, non-initial tagged data pieces of a collection having a common fragment size do not need to occupy the full fragment size if all data for the data field of the non-initial tagged data piece has not been written. In other words, non-volatile memory space can be saved by writing a tagged data piece of a collection with less than a complete data field when less than a complete data field is required for the data currently being written. This saving of memory space is in contrast to known memory systems where full memory blocks may be assigned whether each full memory block is being written to at the time or not.

It may also be useful to keep track of a run-time mode of a collection of tagged data pieces in addition to the status stored in the data field of the initial tagged data piece of the collection. In particular, a portion of random access memory of the memory controller can be dynamically allocated to store parameters relating to a run-time mode of a collection of tagged data pieces stored in non-volatile memory. When a client application accesses a collection of data stored in a collection of tagged data pieces, the collection of tagged data pieces can be opened by its associated file name stored in the initial tagged data piece and with a mode indicator. If the file name matches a file name stored in an initial tagged data piece (having the initial fragment identification such as zero), a portion of the memory controller RAM is assigned to keep track of the parameters for the opened collection of tagged data pieces, and a unique index number is passed back to the client application. The client application can then use the index number (also known as a file descriptor) for further access, such as reading or writing data.

If the mode indicator is set to allow read access, then write access can be prevented. Likewise, if the mode indicator is set to allow write access, read access can be prevented. According to embodiments of the present invention including a mode indicator, the collection of tagged data pieces used to store a collection of data in non-volatile integrated circuit memory can be managed by the memory controller without necessarily knowing where the tagged data pieces of the collection are when the collection is not open. When the collection of tagged data pieces is opened, the locations of the tagged data pieces can be collected in a fragment list stored in dynamic memory 34 of memory controller 33 as discussed above with regard to FIGS. 19A and 19B, and the collection can be accessed for reading, writing, or removal of the file.

When a collection of tagged data pieces is closed, the fragment list for the collection can be removed from dynamic memory, thereby releasing dynamic memory space used to store the fragment list. If the collection of tagged data pieces is to be opened in multiple instances by different applications, the fragment list may be maintained in dynamic memory until all of the different applications have ceased accessing the collection.

Collections of tagged data pieces can also be used to store and retrieve database information in non-volatile integrated circuit memory, such as flash memory, according to embodiments of the present invention. As discussed herein, a database is a named entity that includes one or more tables, with each table including one or more records and corresponding record numbers. More particularly, each table includes a sequentially numbered set of records, and each record may include one or more fields. The format of each record and field will be known to the application that created the table and may vary from table to table. Each field includes a type of data such as alphabetic or numeric data, and a field might include a text memo, a filename reference, or a date and/or time. Numeric or alphabetic fields can be used to reference another table through an index to provide a relational database implementation.

According to embodiments of the present invention, a database header can be stored in a tagged data piece in non-volatile memory with a database tag identification, and each table can be stored as a collection of tagged data pieces in non-volatile memory with each table being assigned a unique table tag identification. Moreover, each table can have an initial tagged data piece with each record of the table being stored in one or more subsequent non-initial tagged data pieces.

In addition, an index can be developed in memory controller dynamic memory wherein the index is a list of the table's records sorted according to the values in one or more fields of the records in the table. Any number of indexes can be created for a table or record set, each with a different sorting criteria. Any records added to a table can be inserted in all indexes for the table according to the respective sorting criteria. Similarly, index entries can be removed for any records that are deleted from the corresponding table. Such an index can thus be created, re-sorted, revised, and used in dynamic memory as long as the corresponding table is being used. Once the index is no longer being used, it can be erased from dynamic memory to provide space.

An index can include a list of record numbers and corresponding fragment identifications for the first tagged data piece used to store the corresponding record in the collection of tagged data pieces. The index, however, does not need to include any actual record data. Although records can be read directly from a table in the order in which they were stored, an index is normally used to access records in a specific order according to the sorting criteria. The application using the particular database can look for records with specific key values using an index, or it can step through the index by moving within the index according to the first, last, next or previous records.

Like an index, a record set can include a list of record numbers for a table in order of a sorting criteria without including actual record data. In addition, a record set may be assembled manually by inserting specific record numbers in a specific order. A record set may also be created as a snapshot of an index. Unlike an index, a record set is stored in non-volatile memory for future use.

A record set is a subset of a table and may include any number of record numbers up to the number of records in the table that it belongs to. Like a table, a record set may have an index applied to it. Since the record set does not include actual record data, the index will be referred to the table for the record data to be used for sorting. A record set can also have other record sets created from it so that any number of refined subsets of the original table may be created. As they are all lists of record numbers in the corresponding table, record sets do not depend on a parent record set once they are created. As record sets may not be automatically updated with new or deleted records, obsolete record sets may remain in non-volatile memory so that an application should not rely on an obsolete record set when adding records to a table.

Each database, table, index, and record set will have a name or number associated with it, and each of these entities can be opened or created as useful. One or more tables and/or record sets can be set to open automatically when the database is opened. The application using a database, for example, can open the database, then open one or more tables of the database, and then create an index to sort the data or open a record set that already has the information sorted. When the application is finished accessing the database, all open entities of the database can be closed when the database is closed. In addition, it is not necessary to open all of the subdatabase entities when using a database according to embodiments of the present invention. Instead, the memory controller can open only those entities of the database to be used, thereby saving time and memory controller dynamic memory space.

Database systems according to embodiments of the present invention can use multiple collections of tagged data pieces for each database stored in non-volatile memory. In particular, a database header can be stored in single tagged data piece according to the format illustrated in FIG. 18 wherein the tagged data piece has a header tag identification and an initial fragment identification such as zero. As shown in FIG. 23, the data field 421 of the database header tagged data piece can include the database name 423, a last update date and time 425, a number of tables in the database 427, and a list of tag identifications 429 for each of the tables of the database. The data field 421 of the database header can also include a list of tables 431 to be opened automatically when the database is opened.

Because the information included in the database header is limited, the database header may be provided in a single tagged data piece identified by the database header tag identification and the initial fragment identification. With a data field 421 of 512 bytes, for example, a relatively large number of two byte table tag identifications can be included in a single tagged data piece.

Each table that is included in a data base is stored as a separate collection of tagged data pieces with each collection of tagged data pieces being assigned a unique table tag identification. As discussed above, each table tag identification of the database is included in the list of table tag identifications 429 in the data field 421 of the database header tagged data piece. For each table, general table information can be stored in an initial tagged data piece of a collection of tagged data pieces, and individual records of the table can be stored in subsequent non-initial tagged data pieces of the collection. More particularly, the initial and non-initial tagged data pieces of the collection for the table have the same table tag identification and different fragment identifications as discussed above with regard to FIGS. 17-20.

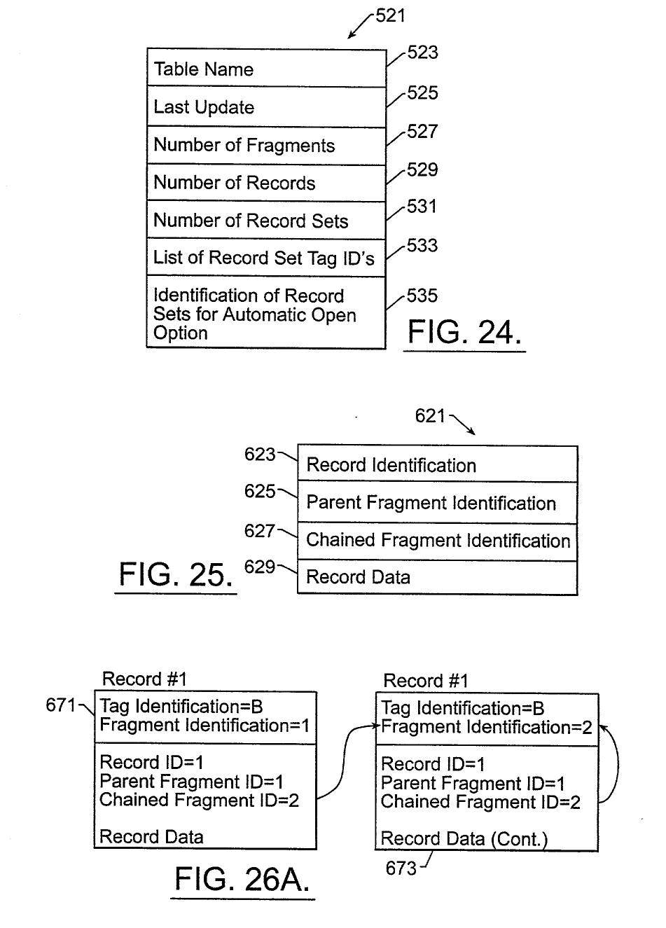

The initial tagged data piece of a table is identified with a tag identification for the table and with the initial fragment identification. The tag identifier for the table is different than the tag identification for the database header and different than tag identifications for other tables in the database. As shown in FIG. 24, the data field 521 for this initial tagged data piece can include a table name 523, a last update time and data for the table 525, a number of fragments in the table 527, a number of records in the table 529, a number of record sets associated with the table 531, and a list of record sets associated with the table identified by tag identification 533. The data field 521 can also include a list of record sets to be opened automatically 535 when the table is opened.

When the table is opened, the record data for the table can thus be collected from the non-initial tagged data pieces of the table stored in non-volatile memory. If the table is set to automatically open with the database to which it belongs, a single scan of non-volatile memory can be used to find the database header tagged data piece and the collection of tagged data pieces of the table. Moreover, any attached record set for the table can be set to open with the table.

Within a table, each record can be stored in flash memory using a single tagged data piece if the record size is no greater than a maximum record size (such as 512 bytes) for a tagged data piece. If the record size for a particular record, however, exceeds the maximum record size, the record may be split into multiple tagged data pieces. In order to accommodate the splitting of a record into multiple tagged data pieces, each non-initial tagged data piece of a table can include a parent fragment identification and a chained fragment identification to indicate a tagged data piece is the beginning of a record, to indicate a next tagged data piece for the record, and/or to indicate that the tagged data piece is the end of the record.

More particularly, each non-initial tagged data piece of a table will be identified with the table tag identification and a non-initial fragment identification, and the data field 621 of each non-initial tagged data piece of a table can include a record identification 623, a parent fragment identification 625, a chained fragment identification 627, and record data 629 as shown in FIG. 25. If the parent fragment identification 625 is the same as the fragment identification of the tagged data piece, the tagged data piece includes the beginning of the record identified by the record identification 623. If the chained fragment identification 627 is equal to the fragment identification of the tagged data piece, the tagged data piece includes the end of the record identified by the record identification 623. If the chained fragment identification 627 refers to a next fragment identification other than the fragment identification of the tagged data piece, additional record data is included in a next tagged data piece. If the fragment identification for a tagged data piece is the same as the parent fragment identification 625 and the chained fragment identification 627, the record indicated by the record identification 623 is completely included in the single tagged data piece.

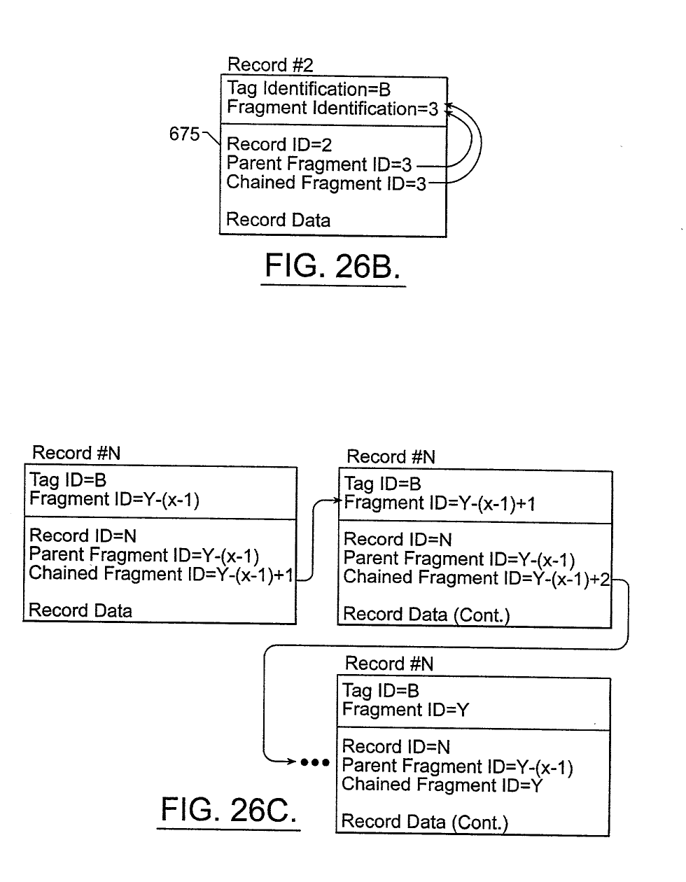

Tagged data pieces of a table can thus reference each other if a record does not fit in a single tagged data piece. Examples of a plurality of non-initial tagged data pieces of a table according to embodiments of the present invention are illustrated in FIGS. 26A-C. As shown in FIG. 26A, Record # 1 of the table with table tag identification B is stored in the first and second non-initial tagged data pieces 671 and 673 of the collection for the table, where the first and second non-initial tagged data pieces have the tag identification B and respective fragment identifications of 1 and 2. As shown, non-initial tagged data piece 671 has a Record identification of 1, a parent fragment identification of 1, a chained fragment identification of 2, and a first portion of the record data. Non-initial tagged data piece 673 has the Record identification of 1, the parent fragment identification of 1, and a chained fragment identification of 2, and the remainder of the record data. The memory controller can thus determine that Record 1 is completely stored in the non-initial tagged data pieces with fragment identifications of 1 and 2 using the parent and chained fragment identifications.

FIG. 26B illustrates a second record of the same table, Record # 2, stored in a single non-initial tagged data piece 675 of the collection for the table. In other words, the record data of Record 2 is no greater that a maximum size that can be stored in a single tagged data piece. Record # 2 is thus stored in a non-initial tagged data piece that is assigned the same tag identification B used for all other tagged data pieces of the collection used to store the table, and that is assigned the next consecutive fragment identification of 3. As further shown, the record identification is 2, and the parent and chained fragment identifications are the same as the fragment identification for the tagged data piece.

FIG. 26C illustrates a final record N for the same table stored in a plurality of X non-initial tagged data pieces of the collection for the table with a final non-initial tagged data piece with a fragment identification of Y. In other words, the table has N records stored in Y non-initial tagged data pieces with the final record N being stored in X tagged data pieces. As shown, the Fragment identification increments for each tagged data piece used to store the record, and the chained fragment identification of each tagged data piece identifies the fragment identification of the next tagged data piece except for the last tagged data piece of the record where the chained fragment identification is the same as the fragment identification.

FIG. 26C is meant to illustrate the principle that any number of non-initial tagged data pieces can be chained to provide storage for a record of any size. While FIG. 26C shows that the final record of a table may occupy three or more tagged data pieces, a final record of a table according to embodiments of the present invention can occupy one or two tagged data pieces as illustrated in FIGS. 26A and 26B. For a table having a final record number of N and a final fragment identification of Y, the initial tagged data piece of the collection can have a fragment identification of 0, a number of non-initial tagged data pieces of Y, and a number of records of N. According to embodiments of the present invention, the number of non-initial tagged data pieces in a table will be greater than or equal to the number of records in the table because no more than one record is stored in a tagged data piece and one record may occupy more than one tagged data piece.

Since a record can be split into multiple fragments, a complete record (including all tagged data pieces used to store the record) can be verified as a whole to reduce the possibility of partially written records due to power loss during the writing of the record. More particularly, when a record is split between multiple tagged data pieces, the field that includes the record number can be left unprogrammed until the entire record is programmed, at which point the record can be programmed to the record number. Accordingly, a record that is corrupted due to an abrupt power loss during. programming can be detected on subsequent power up.

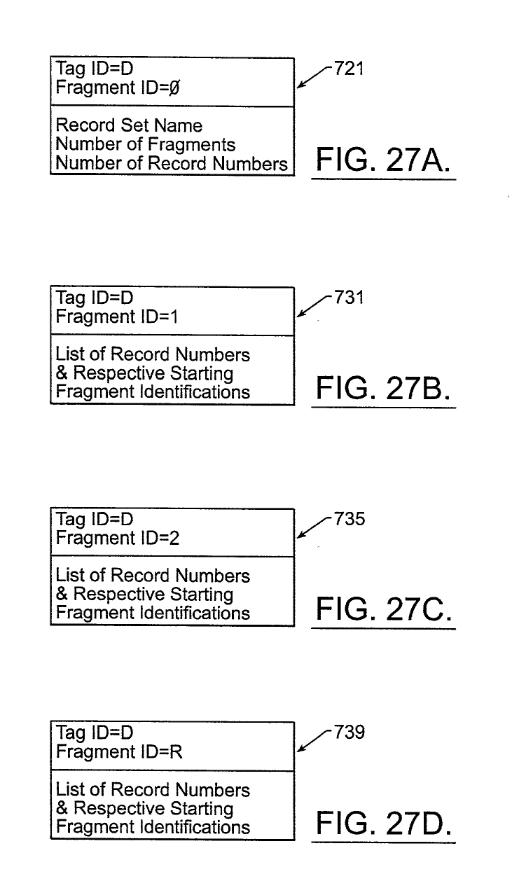

A record set is a list of record numbers together with the respective starting fragment identifications, and a record set can be stored in tagged data pieces having a common tag identification and sequential fragment identifications as discussed above with respect to files. As shown in FIGS. 27A-D, a collection of tagged data pieces may be used to store a record set in non-volatile memory where each tagged data piece of the record set is identified by a record set tag identification D that is different from the tag identification of the corresponding database header tagged data piece (illustrated in FIG. 23) and that is different from the tag identification of the corresponding table tagged data pieces (illustrated in FIGS. 24, 25, and 26A-C).

FIG. 27A illustrates an initial tagged data piece 721 of a record set collection identified by the tag identification D and an initial fragment identification of zero. A data field of the initial tagged data piece of the record set can include a record set name, a number of non-initial tagged data pieces (equal to the highest non-initial fragment identification in the record set) in the record set collection, and a number of record numbers in the table corresponding to the record set. The tag identification D of the record set will be identified in the initial tagged data piece of the corresponding table as discussed above with regard to FIG. 24, and the tag identification of the table will be identified in the database header tagged data piece as discussed above with regard to FIG. 23. Accordingly, the database header tagged data piece can be used to locate all tables of the database, which can in turn be used to locate all record sets of the tables.

Data fields of non-initial tagged data pieces 731, 735, and 739 of the record set can be used to save a list of record numbers and their respective starting fragment identifications in the corresponding table as illustrated in FIGS. 27B-D. The non-initial tagged data pieces of the record set will have the same tag identification D as the initial tagged data piece, and the non-initial tagged data pieces can have consecutive non-initial fragment identifications 1-R. As shown, the list of record numbers and starting fragment identifications may occupy any number of non-initial tagged data pieces from 1 to R depending on the number of records in the table and the maximum size of the data field.

Alternatively, a file system can be used to store record sets instead of directly using respective tag identifications. While inserting or deleting a record in a record set may result in rewriting the record set, only a relatively small amount of non-volatile memory is required.

Because indexes according to embodiments of the present invention are not stored in non-volatile memory, an index can be updated in the dynamic memory of the memory controller. Each index includes a list of record numbers for the table being indexed and the respective starting fragment identifications. In addition, an index can be configured by providing the record offset of the key field in bytes, the size of the key field in bytes, and the key comparison type. When sorting a table's records, an index can access the key fields of the record directly in flash memory via the fragment list of the table. This operation may be faster than reading each record into a buffer and then comparing its key fields. Any known sorting algorithm can be used to sort the index.

The storage of a relational database as discussed above with regard to FIGS. 23-27 may provide flexibility while reducing runtime requirements for usage in a cellular radiotelephone. The amount of dynamic memory used will increase with the number of records in an open table. Even though a database may include a relatively large number of tables, dynamic memory space can be saved by opening only those tables that pertain to the application using the database at that time. The dynamic memory used to track open collections of data in non-volatile memory can thus be reduced. When the application is finished with the database, the database can be closed and the dynamic memory dedicated to the database can be used for other purposes.

Database methods and systems according to embodiments of the present invention can also reduce non-volatile memory usage in that only records actually stored in a table need to be saved in non-volatile memory space. In other words, there is no need to pre-allocate blocks of non-volatile memory prior to storing records of a table. If there are only 10 entries in a phonebook database, for example, then only those 10 entries will use any non-volatile memory space as opposed to pre-allocating for a maximum number of entries (such as 4000) that can be entered in the database. Processing burdens of the memory controller can thus be reduced, and life of a non-volatile flash memory device can be increased.

Because records can be stored in tagged data pieces that can be of variable size, the waste of partially used memory blocks of fixed size can be reduced. Moreover, database systems and methods according to embodiments of the present invention do not necessarily depend on the file system at all, and can instead be run as a stand-alone client of the system directory.

In addition, once database tables are open, they may be sorted relatively quickly according to multiple criteria to provide fast record data as requested by the particular application. An application can setup the tables that should be opened with the database when it is first opened. Accordingly, the database, any relevant tables, and any relevant record sets can be located in a single scan of flash memory.

Unlike other known database systems, record sets according to embodiments of the present invention can be stored in non-volatile memory as opposed to being stored in dynamic memory only. A phonebook database that remains unchanged for most of the time can thus load a pre-sorted record set rather than creating and sorting an index each time the phonebook needs to be accessed.

For purposes of illustration and in no way limited thereto, the present invention has been described in the context of memory controllers for flash memory devices, and memory controllers for mobile communications terminals. It will be understood, however, that the concepts and principles of the present invention may be applied to managing alternate types of memory devices in other types of information processing systems.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The flowcharts of FIGS. 3-4, 6-11, 14, and 28-33 show architectures, functionalities, and operations of exemplary implementations of software and data used, for example, by a memory controller 33 to control a memory device 31 according to the present invention. In this regard, each block may represent a module, segment, or portion of code, which comprises one or more executable instructions for implementing the specified logical function(s). It should also be noted that in some alternative implementations, functions noted in the blocks may occur out of the order noted in FIGS. 3-4, 6-11, 14, and 28-33. For example, two blocks shown in succession in FIGS. 3-4, 6-11, 14, and 28-33 may be executed substantially concurrently or the blocks may sometimes be executed in the reverse order, depending upon the functionality involved.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed:

1. A method of storing collections of related data in memory, said method comprising:
storing a first collection of related data in a first collection of tagged data pieces wherein each tagged data piece of the first collection comprises a respective header including a first tag identification common to each of the tagged data pieces of the first collection and a fragment identification unique to each of the tagged data pieces of the first collection; and
storing a second collection of related data in a second collection of tagged data pieces wherein each tagged data piece of the second collection comprises a respective header including a second tag identification common to each of the tagged data pieces of the second collection and a fragment identification unique to each of the tagged data pieces of the second collection wherein the first and second tag identifications are distinct.

2. The method according to claim 1 wherein each of the tagged data pieces is stored in consecutive memory cells of the memory, wherein at least one of the tagged data pieces of the first collection is stored in memory cells not consecutive with respect to any other tagged data pieces of the first collection, and wherein at least one of the tagged data pieces of the second collection is stored in memory cells not consecutive with respect to any other tagged data pieces of the second collection.

3. The method according to claim 1 wherein each of the first and second collections comprises a respective initial tagged data piece including data used to access the respective collection of tagged data pieces.

4. The method according to claim 3 wherein the data used to access the respective collection of tagged data pieces comprises a number of tagged data pieces in the collection.

5. The method according to claim 4 wherein the number of tagged data pieces in the collection is a number of non-initial tagged data pieces in the collection.

6. The method according to claim 3 wherein each of the initial tagged data pieces comprises a same initial fragment identification.

7. The method according to claim 6 wherein the same initial fragment identification is zero.

8. The method according to claim 3 further comprising:
generating a sorted list including the first and second tag identifications and respective addresses of the first and second initial tagged data pieces.

9. The method according to claim 8 wherein the collections of tagged data pieces are stored in non-volatile memory.

10. The method according to claim 8 further comprising:
generating an all list including a pointer to the sorted list.

11. The method according to claim 10 further comprising:
generating a fragment list for the first collection of tagged data pieces wherein the fragment list includes pointers for respective addresses of the tagged data pieces of the first collection; and
wherein the all list includes a pointer to the fragment list for the first collection.

12. The method according to claim 1 further comprising:
generating a fragment list for the first collection of tagged data pieces wherein the fragment list includes pointers for respective addresses of the tagged data pieces of the first collection.

13. The method according to claim 12 wherein the collections of tagged data pieces are stored in non-volatile memory and the fragment list is stored in dynamic memory.

14. The method according to claim 1 wherein the first and second collections of tagged data pieces are stored in non-volatile integrated circuit memory.

15. The method according to claim 14 wherein the non-volatile integrated circuit memory comprises flash memory.

16. A method of providing a system directory, the method comprising:
storing a first plurality of entry identifications as a first tagged data piece comprising a tag identification for the system directory and a first fragment identification; and
storing a second plurality of entry identifications in a second tagged data piece comprising the tag identification for the system directory and a second fragment identification different than the first fragment identification.

17. The method according to claim 16 wherein the first tagged data piece comprises a first chained fragment identification equal to the second fragment identification and wherein the second tagged data piece comprises a second chained fragment identification equal to a terminal identification.

18. The method according to claim 17 wherein the terminal identification is equal to the second fragment identification.

19. The method according to claim 16 further comprising:
storing a collection of related data in a collection of tagged data pieces wherein each tagged data piece of the collection includes a second tag identification common to each of the tagged data pieces of the collection and a fragment identification unique to each of the tagged data pieces of the collection wherein the second tag identification is different than the tag identification for the system directory and wherein at least one of the entry identifications is equal to the second tag identification.

20. The method according to claim 19 wherein the collection of related data comprises at least one of a data base and/or a file.

21. The method according to claim 19 wherein storing the first tagged data pieces including the entry identification equal to the second tag identification precedes storing the collection of related data in the collection of tagged data pieces.

22. The method according to claim 16 wherein at least one of the entry identifications of the first plurality is equal to the second fragment identification.

23. The method according to claim 16 wherein the first and second tagged data pieces are stored in the non-volatile integrated circuit memory.

24. The method according to claim 23 wherein the non-volatile integrated circuit memory comprises flash memory.

25. A method of storing a collection of data in memory, said method comprising:
storing an initial tagged data piece comprising a collection tag identification, an initial fragment identification, and a data field wherein the data field comprises a fragment size defining a maximum size of all non-initial tagged data pieces having the collection tag identification, and a number of fragments defining a number of non-initial tagged data pieces for the collection;
storing a first non-initial tagged data piece comprising the collection tag identification, a first non-initial fragment identification, and a data field wherein the data field comprises a first portion of the collection of data; and
storing a second non-initial tagged data piece comprising the collection tag identification, a second non-initial fragment identification, and a data field wherein the data field comprises a second portion of the collection of data, wherein the initial fragment identification, the first non-initial fragment identification, and the second non-initial fragment identification are all different.

26. The method according to claim 25 wherein each of the fragment identifications comprises a number with the first non-initial fragment identification being between the initial fragment identification and the second non-initial fragment identification.

27. The method according to claim 26 wherein the first and second non-initial fragment identifications comprise non-consecutive numbers and wherein storing the first and second non-initial tagged data pieces comprises storing the first and second non-initial tagged data pieces within the memory device such that no other tagged data pieces comprise both the collection tag identification and a fragment identification between the first and second non-initial tag identification at the time of storing the first and second non-initial tagged data pieces.

28. The method according to claim 26 wherein storing the first and second non-initial tagged data pieces are followed by:
storing a third non-initial tagged data piece comprising the collection tag identification, a third non-initial fragment identification, and a data field wherein the data field comprises a third portion of the collection of data, wherein the third non-initial fragment identification is between the first and second non-initial fragment identifications.

29. The method according to claim 26 wherein the initial tagged data piece and the first and second non-initial tagged data pieces are stored in non-volatile memory, the method further comprising:
before storing the third non-initial tagged data piece, storing a fragment list in dynamic memory wherein the fragment list includes entries for the first, second, and third tagged data pieces, and wherein before storing the third tagged data piece, the entry for the first non-initial tagged data piece comprises a non-volatile memory address of the first non-initial tagged data piece, the entry for the second non-initial tagged data piece comprises a non-volatile memory address for the second non-initial tagged data piece, and where the entry for the third non-initial data piece comprises a NULL entry to indicate that the third non-initial data piece has not been stored in non-volatile memory.

30. The method according to claim 29 further comprising:
after storing the third non-initial tagged data piece, updating the fragment list entry for the third non-initial tagged data piece to a non-volatile memory address for the third non-initial tagged data piece.

31. The method according to claim 29 wherein a number of entries in the fragment list is equal to the number of fragments defining the number of non-initial tagged data pieces for the collection.

32. The method according to claim 26 wherein the initial fragment identification is equal to zero and the second non-initial fragment identification is equal to the number of fragments defining the number of non-initial tagged data pieces for the collection.

33. The method according to claim 25 wherein the data field of the initial tagged data piece further comprises a file status, the method further comprising:
before storing the first and second non-initial tagged data pieces, storing a WRITING status as the file status; and
after storing the first and second non-initial tagged data pieces, storing a NORMAL status as the file status.

34. The method according to claim 25 further comprising:
before storing the WRITING status as the file status, storing a CREATED status as the file status.

35. The method according to claim 33 further comprising:
after storing the NORMAL status as the file status, storing a REMOVING status as the file status; and
after storing the REMOVING status as the file status, removing all tagged data pieces having the collection tag identification from memory.

36. The method according to claim 35 wherein removing all tagged data pieces having the collection tag identification from memory comprises first removing the non-initial tagged data pieces and then removing the initial tagged data piece.

37. The method according to claim 25 wherein storing the initial tagged data piece and the first and second non-initial tagged data pieces comprises storing the initial tagged data piece and the first and second non-initial tagged data pieces in non-volatile integrated circuit memory.

38. The method according to claim 37 wherein the non-volatile integrated circuit memory comprises flash memory.

39. A method of storing a database including at least one table made up of a plurality of records and corresponding record numbers in memory, the method comprising:
storing a first record of a table and a corresponding first record number in a first tagged data piece wherein the first tagged data piece comprises a table tag identification and a first fragment identification; and
storing a second record of the table and a corresponding second record number in a second tagged data piece wherein the second tagged data piece comprises the table tag identification and a second fragment identification different than the first fragment identification.

40. The method according to claim 39 further comprising:
storing a table header in an initial tagged data piece for the table wherein the initial tagged data piece comprises the table tag identification, an initial fragment identification, and a number of records in the table.

41. The method according to claim 40 wherein the initial fragment identification is zero and wherein the first and second fragment identifications are consecutive non-zero fragment identifications.

42. The method according to claim 40 further comprising:
storing a database header in a database tagged data piece comprising a database tag identification different than the table tag identification, a number of tables in the data base, and a list of table identifications for all tables in the database, the list including the table tag identification.

43. The method according to claim 40 further comprising:
storing a record set for the table in a record set tagged data piece comprising a record set tag identification different than the table tag identification, a list of record numbers in the table, and a list of fragment identifications corresponding to the record numbers.

44. The method according to claim 43 wherein the initial tagged data piece for the table header further comprises the record set tag identification identifying the record set tagged data piece.

45. The method according to claim 39 wherein the first tagged data piece comprises a first group of consecutive memory cells in non-volatile integrated circuit memory, and wherein the second tagged data piece comprises a second group of consecutive memory cells in non-volatile integrated circuit memory.

46. The method according to claim 45 further comprising:
generating an index for the table in dynamic memory wherein the index includes a list of record numbers including the first and second record numbers.

47. The method according to claim 45 wherein the non-volatile integrated circuit memory comprises flash memory.

48. The method according to claim 39 wherein the first and second tagged data pieces are stored in non-volatile integrated circuit memory.

49. The method according to claim 48 wherein the non-volatile integrated circuit memory comprises flash memory.

50. A computer program product for storing collections of related data in memory, the computer program product comprising a computer-readable storage medium having computer-readable program code embodied therein, the computer-readable program code comprising:
computer-readable program code that stores a first collection of related data in a first collection of tagged data pieces wherein each tagged data piece of the first collection comprises a respective header including a first tag identification common to each of the tagged data pieces of the first collection and a fragment identification unique to each of the tagged data pieces of the first collection; and
computer-readable program code that stores a second collection of related data in a second collection of tagged data pieces wherein each tagged data piece of the second collection comprises a respective header including a second tag identification common to each of the tagged data pieces of the second collection and a fragment identification unique to each of the tagged data pieces of the second collection wherein the first and second tag identifications are distinct.

51. The computer program product according to claim 50 wherein each of the tagged data pieces is stored in consecutive memory cells of the memory, wherein at least one of the tagged data pieces of the first collection is stored in memory cells not consecutive with respect to any other tagged data pieces of the first collection, and wherein at least one of the tagged data pieces of the second collection is stored in memory cells not consecutive with respect to any other tagged data pieces of the second collection.

52. The computer program product according to claim 50 wherein each of the first and second collections comprises a respective initial tagged data piece including data used to access the respective collection of tagged data pieces.

53. The computer program product according to claim 52 wherein the data used to access the respective collection of tagged data pieces comprises a number of tagged data pieces in the collection.

54. The computer program product according to claim 53 wherein the number of tagged data pieces in the collection is a number of non-initial tagged data pieced in the collection.

55. The computer program product according to claim 52 wherein each of the initial tagged data pieces comprises a same initial fragment identification.

56. The computer program product according to claim 55 wherein the same initial fragment identification is zero.

57. The computer program product according to claim 52 further comprising:
computer-readable program code that generates a sorted list including the first and second tag identifications and respective addresses of the first and second initial tagged data pieces.

58. The computer program product according to claim 57 wherein the collections of tagged data pieces are stored in non-volatile memory.

59. The computer program product according to claim 57 further comprising:
computer-readable program code that generates an all list including a pointer to the sorted list.

60. The computer program product according to claim 59 further comprising:
computer-readable program code that generates a fragment list for the first collection of tagged data pieces wherein the fragment list includes pointers for respective addresses of the tagged data pieces of the first collection;
and wherein the all list includes a pointer to the fragment list for the first collection.

61. The computer program product according to claim 50 further comprising:
computer-readable program code that generates a fragment list for the first collection of tagged data pieces wherein the fragment list includes pointers for respective addresses of the tagged data pieces of the first collection.

62. The computer program product according to claim 61 wherein the collections of tagged data pieces are stored in non-volatile memory and the fragment list is stored in dynamic memory.

63. The computer program product according to claim 50 wherein the first and second collections of tagged data pieces are stored in non-volatile integrated circuit memory.

64. The computer program product according to claim 63 wherein the non-volatile integrated circuit memory comprises flash memory.

65. A computer program product for providing a system directory, the computer program product comprising a computer-readable storage medium having computer-readable program code embodied in the medium, the computer-readable program code comprising:
computer-readable program code that stores a first plurality of entry identifications as a first tagged data piece comprising a tag identification for the system directory and a first fragment identification; and
computer-readable program code that stores a second plurality of entry identifications in a second tagged data piece comprising the tag identification for the system directory and a second fragment identification different than the first fragment identification.

66. The computer program product according to claim 65 wherein the first tagged data piece comprises a first chained fragment identification equal to the second fragment identification and wherein the second tagged data piece comprises a second chained fragment identification equal to a terminal identification.

67. The computer program product according to claim 66 wherein the terminal identification is equal to the second fragment identification.

68. The computer program product according to claim 65 further comprising:
computer-readable program code that stores a collection of related data in a collection of tagged data pieces wherein each tagged data piece of the collection includes a second tag identification common to each of the tagged data pieces of the collection and a fragment identification unique to each of the tagged data pieces of the collection wherein the second tag identification is different than the tag identification for the system directory and wherein at least one of the entry identifications is equal to the second tag identification.

69. The computer program product according to claim 68 wherein the collection of related data comprises at least one of a data base and/or a file.

70. The computer program product according to claim 68 wherein storing the first tagged data pieces including the entry identification equal to the second tag identification precedes storing the collection of related data in the collection of tagged data pieces.

71. The computer program product according to claim 65 wherein at least one of the entry identifications of the first plurality is equal to the second fragment identification.

72. The computer program product according to claim 65 wherein the first and second tagged data pieces are stored in the non-volatile integrated circuit memory.

73. The computer program product according to claim 72 wherein the non-volatile integrated circuit memory comprises flash memory.

74. A computer program product for storing a collection of data in memory, the computer program product comprising a computer-readable storage medium having computer-readable program code embodied in the medium, the computer-readable program code comprising:
computer-readable program code that stores an initial tagged data piece comprising a collection tag identification, an initial fragment identification, and a data field wherein the data field comprises a fragment size defining a maximum size of all non-initial tagged data pieces having the collection tag identification, and a number of fragments defining a number of non-initial tagged data pieces for the collection;
computer-readable program code that stores a first non-initial tagged data piece comprising the collection tag identification, a first non-initial fragment identification, and a data field wherein the data field comprises a first portion of the collection of data; and
computer-readable program code that stores a second non-initial tagged data piece comprising the collection tag identification, a second non-initial fragment identification, and a data field wherein the data field comprises a second portion of the collection of data, wherein the initial fragment identification, the first non-initial fragment identification, and the second non-initial fragment identification are all different.

75. The computer program product according to claim 74 wherein each of the fragment identifications comprises a number with the first non-initial fragment identification being between the initial fragment identification and the second non-initial fragment identification.

76. The computer program product according to claim 75 wherein the first and second non-initial fragment identifications comprise non-consecutive numbers and wherein storing the first and second non-initial tagged data pieces comprises storing the first and second non-initial tagged data pieces within the memory device such that no other tagged data pieces comprise both the collection tag identification and a fragment identification between the first and second non-initial tag identification at the time of storing the first and second non-initial tagged data pieces.

77. The computer program product according to claim 75 wherein storing the first and second non-initial tagged data pieces are followed by:
computer-readable program code that stores a third non-initial tagged data piece comprising the collection tag identification, a third non-initial fragment identification, and a data field wherein the data field comprises a third portion of the collection of data, wherein the third non-initial fragment identification is between the first and second non-initial fragment identifications.

78. The computer program product according to claim 75 wherein the initial tagged data piece and the first and second non-initial tagged data pieces are stored in non-volatile memory, the method further comprising:
computer-readable program code that, before storing the third non-initial tagged data piece, stores a fragment list in dynamic memory wherein the fragment list includes entries for the first, second, and third tagged data pieces, and wherein before storing the third tagged data piece, the entry for the first non-initial tagged data piece comprises a non-volatile memory address of the first non-initial tagged data piece, the entry for the second non-initial tagged data piece comprises a non-volatile memory address for the second non-initial tagged data piece, and where the entry for the third non-initial data piece comprises a NULL entry to indicate that the third non-initial data piece has not been stored in non-volatile memory.

79. The computer program product according to claim 78 further comprising:
computer-readable program code that, after storing the third non-initial tagged data piece, updates the fragment list entry for the third non-initial tagged data piece to a non-volatile memory address for the third non-initial tagged data piece.

80. The computer program product according to claim 78 wherein a number of entries in the fragment list is equal to the number of fragments defining the number of non-initial tagged data pieces for the collection.

81. The computer program product according to claim 75 wherein the initial fragment identification is equal to zero and the second non-initial fragment identification is equal to the number of fragments defining the number of non-initial tagged data pieces for the collection.

82. The computer program product according to claim 74 wherein the data field of the initial tagged data piece further comprises a file status, the method further comprising:
computer-readable program code that, before storing the first and second non-initial tagged data pieces, stores a WRITING status as the file status; and
after storing the first and second non-initial tagged data pieces, storing a NORMAL status as the file status.

83. The computer program product according to claim 74 further comprising:
computer-readable program code that, before storing the WRITING status as the file status, stores a CREATED status as the file status.

84. The computer program product according to claim 82 further comprising:
computer-readable program code that, after storing the NORMAL status as the file status, stores a REMOVING status as the file status; and
computer-readable program code that, after storing the REMOVING status as the file status, removes all tagged data pieces having the collection tag identification from memory.

85. The computer program product according to claim 84 wherein removing all tagged data pieces having the collection tag identification from memory comprises first removing the non-initial tagged data pieces and then removing the initial tagged data piece.

86. The computer program product according to claim 74 wherein storing the initial tagged data piece and the first and second non-initial tagged data pieces comprises storing the initial tagged data piece and the first and second non-initial tagged data pieces in non-volatile integrated circuit memory.

87. The computer program product according to claim 86 wherein the non-volatile integrated circuit memory comprise flash memory.

88. A computer program product for storing a database including at least one table made up of a plurality of records and corresponding record numbers in memory, the computer program product comprising a computer-readable storage medium having computer-readable program code embodied in the medium, the computer-readable program code comprising:
computer-readable program code that stores a first record of a table and a corresponding first record number in a first tagged data piece wherein the first tagged data piece comprises a table tag identification and a first fragment identification; and
computer-readable program code that stores a second record of the table and a corresponding second record number in a second tagged data piece wherein the second tagged data piece comprises the table tag identification and a second fragment identification different than the first fragment identification.

89. The computer program product according to claim 80 further comprising:
computer-readable program code that stores a table header in an initial tagged data piece for the table wherein the initial tagged data piece comprises the table tag identification, an initial fragment identification, and a number of records in the table.

90. The computer program product according to claim 89 wherein the initial fragment identification is zero and wherein the first and second fragment identifications are consecutive non-zero fragment identifications.

91. The computer program product according to claim 89 further comprising:
computer-readable program code that stores a database header in a database tagged data piece comprising a database tag identification different than the table tag identification, a number of tables in the data base, and a list of table identifications for all tables in the database, the list including the table tag identification.

92. The computer program product according to claim 89 further comprising:
computer-readable program code that stores a record set for the table in a record set tagged data piece comprising a record set tag identification different than the table tag identification, a list of record numbers in the table, and a list of fragment identifications corresponding to the record numbers.

93. The computer program product according to claim 92 wherein the initial tagged data piece for the table header further comprises the record set tag identification identifying the record set tagged data piece.

94. The computer program product according to claim 88 wherein the first tagged data piece comprises a first group of consecutive memory cells in non-volatile integrated circuit memory, and wherein the second tagged data piece comprises a second group of consecutive memory cells in non-volatile integrated circuit memory.

95. The computer program product according to claim 94 further comprising:
computer-readable program code that generates an index for the table in dynamic memory wherein the index includes a list of record numbers including the first and second record numbers.

96. The computer program product according to claim 94 wherein the non-volatile integrated circuit memory comprises flash memory.

97. The computer program product according to claim 88 wherein the first and second tagged data pieces are stored in non-volatile integrated circuit memory.

98. The computer program product according to claim 97 wherein the non-volatile integrated circuit memory comprises flash memory.

99. An information processing system comprising:
a memory controller that stores a first collection of related data in a first collection of tagged data pieces wherein each tagged data piece of the first collection comprises a respective header including a first tag identification common to each of the tagged data pieces of the first collection and a fragment identification unique to each of the tagged data pieces of the first collection, and that stores a second collection of related data in a second collection of tagged data pieces wherein each tagged data piece of the second collection comprises a respective header including a second tag identification common to each of the tagged data pieces of the second collection and a fragment identification unique to each of the tagged data pieces of the second collection wherein the first and second tag identifications are distinct.

100. The information processing system according to claim 99 wherein each of the tagged data pieces is stored in consecutive memory cells of the memory, wherein at least one of the tagged data pieces of the first collection is stored in memory cells not consecutive with respect to any other tagged data pieces of the first collection, and wherein at least one of the tagged data pieces of the second collection is stored in memory cells not consecutive with respect to any other tagged data pieces of the second collection.

101. The information processing system according to claim 99 wherein each of the first and second collections comprises a respective initial tagged data piece including data used to access the respective collection of tagged data pieces.

102. The information processing system according to claim 101 wherein the data used to access the respective collection of tagged data pieces comprises a number of tagged data pieces in the collection.

103. The information processing system according to claim 102 wherein the number of tagged data pieces in the collection is a number of non-initial tagged data pieced in the collection.

104. The information processing system according to claim 101 wherein each of the initial tagged data pieces comprises a same initial fragment identification.

105. The information processing system according to claim 104 wherein the same initial fragment identification is zero.

106. The information processing system according to claim 101 wherein the memory controller further generates a sorted list including the first and second tag identifications and respective addresses of the first and second initial tagged data pieces.

107. The information processing system according to claim 106 wherein the collections of tagged data pieces are stored in non-volatile memory.

108. The information processing system according to claim 106 wherein the memory controller further generates an all list including a pointer to the sorted list.

109. The information processing system according to claim 108 wherein the memory controller further generates a fragment list for the first collection of tagged data pieces wherein the fragment list includes pointers for respective addresses of the tagged data pieces of the first collection and wherein the all list includes a pointer to the fragment list for the first collection.

110. The information processing system according to claim 99 wherein the memory controller further generates a fragment list for the first collection of tagged data pieces wherein the fragment list includes pointers for respective addresses of the tagged data pieces of the first collection.

111. The information processing system according to claim 110 wherein the collections of tagged data pieces are stored in non-volatile memory and the fragment list is stored in dynamic memory.

112. The information processing system according to claim 99 wherein the first and second collections of tagged data pieces are stored in non-volatile integrated circuit memory.

113. The information processing system according to claim 112 wherein the non-volatile integrated circuit memory comprises flash memory.

114. An information processing system that provides a system directory, the information processing system comprising:
a memory controller that stores a first plurality of entry identifications as a first tagged data piece comprising a tag identification for the system directory and a first fragment identification, and that stores a second plurality of entry identifications in a second tagged data piece comprising the tag identification for the system directory and a second fragment identification different than the first fragment identification.

115. The information processing system according to claim 114 wherein the first tagged data piece comprises a first chained fragment identification equal to the second fragment identification and wherein the second tagged data piece comprises a second chained fragment identification equal to a terminal identification.

116. The information processing system according to claim 115 wherein the terminal identification is equal to the second fragment identification.

117. The information processing system according to claim 114 wherein the memory controller further stores a collection of related data in a collection of tagged data pieces wherein each tagged data piece of the collection includes a second tag identification common to each of the tagged data pieces of the collection and a fragment identification unique to each of the tagged data pieces of the collection wherein the second tag identification is different than the tag identification for the system directory and wherein at least one of the entry identifications is equal to the second tag identification.

118. The information processing system according to claim 117 wherein the collection of related data comprises at least one of a data base and/or a file.

119. The information processing system according to claim 117 wherein storing the first tagged data pieces including the entry identification equal to the second tag identification precedes storing the collection of related data in the collection of tagged data pieces.

120. The information processing system according to claim 114 wherein at least one of the entry identifications of the first plurality is equal to the second fragment identification.

121. The information processing system according to claim 114 wherein the first and second tagged data pieces are stored in the non-volatile integrated circuit memory.

122. The information processing system according to claim 121 wherein the non-volatile integrated circuit memory comprises flash memory.

123. The information processing system of storing a collection of data in memory, said information processing system comprising:
a memory controller that stores an initial tagged data piece comprising a collection tag identification, an initial fragment identification, and a data field wherein the data field comprises a fragment size defining a maximum size of all non-initial tagged data pieces having the collection tag identification, and a number of fragments defining a number of non-initial tagged data pieces for the collection, that stores a first non-initial tagged data piece comprising the collection tag identification, a first non-initial fragment identification, and a data field wherein the data field comprises a first portion of the collection of data, and that stores a second non-initial tagged data piece comprising the collection tag identification, a second non-initial fragment identification, and a data field wherein the data field comprises a second portion of the collection of data, wherein the initial fragment identification, the first non-initial fragment identification, and the second non-initial fragment identification are all different.

124. The information processing system according to claim 123 wherein each of the fragment identifications comprises a number with the first non-initial fragment identification being between the initial fragment identification and the second non-initial fragment identification.

125. The information processing system according to claim 124 wherein the first and second non-initial fragment identifications comprise non-consecutive numbers and wherein storing the first and second non-initial tagged data pieces comprises storing the first and second non-initial tagged data pieces within the memory device such that no other tagged data pieces comprise both the collection tag identification and a fragment identification between the first and second non-initial tag identification at the time of storing the first and second non-initial tagged data pieces.

126. The information processing system according to claim 124 wherein after storing the first and second non-initial tagged data pieces, the memory controller stores a third non-initial tagged data piece comprising the collection tag identification, a third non-initial fragment identification, and a data field wherein the data field comprises a third portion of the collection of data, wherein the third non-initial fragment identification is between the first and second non-initial fragment identifications.

127. The information processing system according to claim 124 wherein the memory controller stores the initial tagged data piece and the first and second non-initial tagged data pieces in non-volatile memory, and wherein before storing the third non-initial tagged data piece, the memory controller stores a fragment list in dynamic memory wherein the fragment list includes entries for the first, second, and third tagged data pieces, and wherein before storing the third tagged data piece, the entry for the first non-initial tagged data piece comprises a non-volatile memory address of the first non-initial tagged data piece, the entry for the second non-initial tagged data piece comprises a non-volatile memory address for the second non-initial tagged data piece, and where the entry for the third non-initial data piece comprises a NULL entry to indicate that the third non-initial data piece has not been stored in non-volatile memory.

128. The information processing system according to claim 127 wherein after storing the third non-initial tagged data piece, the memory controller updates the fragment list entry for the third non-initial tagged data piece to a non-volatile memory address for the third non-initial tagged data piece.

129. The information processing system according to claim 127 wherein a number of entries in the fragment list is equal to the number of fragments defining the number of non-initial tagged data pieces for the collection.

130. The information processing system according to claim 124 wherein the initial fragment identification is equal to zero and the second non-initial fragment identification is equal to the number of fragments defining the number of non-initial tagged data pieces for the collection.

131. The information processing system according to claim 123 wherein the data field of the initial tagged data piece further comprises a file status, wherein before storing the first and second non-initial tagged data pieces, the memory controller stores a WRITING status as the file status, and wherein after storing the first and second non-initial tagged data pieces, the memory controller stores a NORMAL status as the file status.

132. The information processing system according to claim 123 wherein before storing the WRITING status as the file status, the memory controller stores a CREATED status as the file status.

133. The information processing system according to claim 131 wherein after storing the NORMAL status as the file status, the memory controller stores a REMOVING status as the file status, and wherein after storing the REMOVING status as the file status, the memory controller removes all tagged data pieces having the collection tag identification from memory.

134. The information processing system according to claim 133 wherein removing all tagged data pieces having the collection tag identification from memory comprises first removing the non-initial tagged data pieces and then removing the initial tagged data piece.

135. The information processing system according to claim 123 wherein storing the initial tagged data piece and the first and second non-initial tagged data pieces comprises storing the initial tagged data piece and the first and second non-initial tagged data pieces in non-volatile integrated circuit memory.

136. The information processing system according to claim 135 wherein the non-volatile integrated circuit memory comprise flash memory.

137. An information processing system of storing a database including at least one table made up of a plurality of records and corresponding record numbers in memory, the information processing system comprising:
a memory controller that stores a first record of a table and a corresponding first record number in a first tagged data piece wherein the first tagged data piece comprises a table tag identification and a first fragment identification, and that stores a second record of the table and a corresponding second record number in a second tagged data piece wherein the second tagged data piece comprises the table tag identification and a second fragment identification different than the first fragment identification.

138. The information processing system according to claim 137 wherein the memory controller further stores a table header in an initial tagged data piece for the table wherein the initial tagged data piece comprises the table tag identification, an initial fragment identification, and a number of records in the table.

139. The information processing system according to claim 138 wherein the initial fragment identification is zero and wherein the first and second fragment identifications are consecutive non-zero fragment identifications.

140. The information processing system according to claim 138 wherein the memory controller further stores a database header in a database tagged data piece comprising a database tag identification different than the table tag identification, a number of tables in the data base, and a list of table identifications for all tables in the database, the list including the table tag identification.

141. The information processing system according to claim 138 wherein the memory controller further stores a record set for the table in a record set tagged data piece comprising a record set tag identification different than the table tag identification, a list of record numbers in the table, and a list of fragment identifications corresponding to the record numbers.

142. The information processing system according to claim 141 wherein the initial tagged data piece for the table header further comprises the record set tag identification identifying the record set tagged data piece.

143. The information processing system according to claim 137 wherein the first tagged data piece comprises a first group of consecutive memory cells in non-volatile integrated circuit memory, and wherein the second tagged data piece comprises a second group of consecutive memory cells in non-volatile integrated circuit memory.

144. The information processing system according to claim 143 wherein the memory controller further generates an index for the table in dynamic memory wherein the index includes a list of record numbers including the first and second record numbers.

145. The information processing system according to claim 143 wherein the non-volatile integrated circuit memory comprises flash memory.

146. The information processing system according to claim 137 wherein the first and second tagged data pieces are stored in non-volatile integrated circuit memory.

147. The information processing system according to claim 146 wherein the non-volatile integrated circuit memory comprises flash memory.
